(19) United States
(12) Patent Application Publication
(10) Pub. No.: US 2025/0024298 A1
(43) Pub. Date: Jan. 16, 2025

(54) INDICATION INFORMATION SENDING METHOD AND APPARATUS, INDICATION INFORMATION RECEIVING METHOD AND APPARATUS, DEVICE, AND STORAGE MEDIUM

(71) Applicant: VIVO MOBILE COMMUNICATION CO., LTD., Dongguan (CN)

(72) Inventors: Jian YAO, Dongguan (CN); Dajie JIANG, Dongguan (CN); Na LI, Dongguan (CN)

(73) Assignee: VIVO MOBILE COMMUNICATION CO., LTD., Dongguan (CN)

(21) Appl. No.: 18/896,883

(22) Filed: Sep. 25, 2024

Related U.S. Application Data
(63) Continuation of application No. PCT/CN2023/084671, filed on Mar. 29, 2023.

(30) Foreign Application Priority Data
Mar. 31, 2022 (CN) 202210346402.1

(51) Int. Cl. H04W 24/10; H04B 7/06; H04W 28/02

(52) U.S. Cl. CPC H04W 24/10; H04B 7/06968; H04W 28/0268

(57) ABSTRACT

An indication information sending method and apparatus, an indication information receiving method and apparatus, a device, and a storage medium, are provided. The indication information sending method includes: sending, by a first device, first indication information to a second device, where the first indication information is used to indicate m pieces of sensing measurement result validity and n pieces of communication data reception correctness, m and n are positive integers, and m+n>2, where m sensing measurement results corresponding to the m pieces of sensing measurement result validity are measurement results of performing sensing measurement on a target signal received by the first device.

### CROSS-REFERENCE TO RELATED APPLICATIONS

This application is a continuation of International Application No. PCT/CN2023/084671, filed on Mar. 29, 2023, which claims priority to Chinese Patent Application No. 202210346402.1, filed Mar. 31, 2022. The entire contents of each of the above-identified applications are expressly incorporated herein by reference.

### TECHNICAL FIELD

This application pertains to the field of communication technologies, and specifically relates to an indication information sending method and apparatus, an indication information receiving method and apparatus, a device, and a storage medium.

### BACKGROUND

A future mobile communication system (for example, a Beyond 5th Generation Mobile Communication Technology (B5G) or a 6th-generation mobile communication system (6G)) has a sensing capability in addition to a communication capability. The sensing capability means that one or more devices that have a sensing capability send and receive a radio signal to sense information such as a direction, a distance, and/or a speed of a target object, or detect, track, identify, or image a target object, a target event, a target environment, or the like. However, currently, a person skilled in the art is still in a discussion stage of how to implement a sensing measurement technology, that is, how to implement sensing measurement is still a technical problem to be resolved.

### SUMMARY

Embodiments of this application provide an indication information sending method and apparatus, an indication information receiving method and apparatus, a device, and a storage medium.

According to a first aspect, an indication information sending method is provided, including:
sending, by a first device, first indication information to a second device, where the first indication information is used to indicate m pieces of sensing measurement result validity and n pieces of communication data reception correctness, m and n are positive integers, and m+n>2, where
m sensing measurement results corresponding to the m pieces of sensing measurement result validity are measurement results of performing sensing measurement on a target signal received by the first device.

According to a second aspect, an indication information receiving method is provided, including:
receiving, by a second device, first indication information sent by a first device, where the first indication information is used to indicate m pieces of sensing measurement result validity and n pieces of communication data reception correctness, and m+n>2, where
m sensing measurement results corresponding to the m pieces of sensing measurement result validity are measurement results of performing sensing measurement on a target signal received by the first device.

According to a third aspect, an indication information sending apparatus is provided, including:
a sending module, configured to send first indication information to a second device, where the first indication information is used to indicate m pieces of sensing measurement result validity and n pieces of communication data reception correctness, m and n are positive integers, and m+n>2, where
m sensing measurement results corresponding to the m pieces of sensing measurement result validity are measurement results of performing sensing measurement on a target signal received by the first device.

According to a fourth aspect, an indication information receiving apparatus is provided, including:
a receiving module, configured to receive first indication information sent by a first device, where the first indication information is used to indicate m pieces of sensing measurement result validity and n pieces of communication data reception correctness, and m+n>2, where
m sensing measurement results corresponding to the m pieces of sensing measurement result validity are measurement results of performing sensing measurement on a target signal received by the first device.

According to a fifth aspect, a communication device is provided. The communication device is a first device and includes a processor and a memory, where the memory stores a program or an instruction that can be run on the processor, and the program or the instruction is executed by the processor to implement the steps of the indication information sending method provided in the embodiments of this application.

According to a sixth aspect, a communication device is provided. The communication device is a first device and includes a processor and a communication interface. The communication interface is configured to send first indication information to a second device, where the first indication information is used to indicate m pieces of sensing measurement result validity and n pieces of communication data reception correctness, m and n are positive integers, and m+n>2, where m sensing measurement results corresponding to the m pieces of sensing measurement result validity are measurement results of performing sensing measurement on a target signal received by the first device.

According to a seventh aspect, a communication device is provided. The communication device is a second device and includes a processor and a memory. The memory stores a program or an instruction that can be run on the processor, and the program or the instruction is executed by the processor to implement the steps of the indication information receiving method provided in the embodiments of this application.

According to an eighth aspect, a communication device is provided. The communication device is a second device and includes a processor and a communication interface. The communication interface is configured to receive first indication information sent by a first device, where the first indication information is used to indicate m pieces of sensing measurement result validity and n pieces of communication data reception correctness, and m+n>2, where m sensing measurement results corresponding to the m pieces of sensing measurement result validity are measurement results of performing sensing measurement on a target signal received by the first device.

According to a ninth aspect, an indication information transmission system is provided, including a first device and a second device, where the terminal may be configured to perform the steps of the indication information sending method according to the first aspect, and the network side device may be configured to perform the steps of the indication information receiving method according to the second aspect.

According to a tenth aspect, a readable storage medium is provided. The readable storage medium stores a program or an instruction, and the program or the instruction is executed by a processor to implement the steps of the indication information sending method according to the first aspect, or the steps of the indication information receiving method according to the second aspect.

According to an eleventh aspect, a chip is provided. The chip includes a processor and a communication interface, the communication interface is coupled to the processor, and the processor is configured to run a program or an instruction to implement the indication information sending method according to the first aspect, or the indication information receiving method according to the second aspect.

According to a twelfth aspect, a computer program/program product is provided. The computer program/program product is stored in a storage medium, and the computer program/program product is executed by at least one processor to implement the indication information sending method according to the first aspect, or the computer program/program product is executed by at least one processor to implement the indication information receiving method according to the second aspect.

In the embodiments of this application, a first device sends first indication information to a second device, where the first indication information is used to indicate m pieces of sensing measurement result validity and n pieces of communication data reception correctness, m and n are positive integers, and m+n>2, where m sensing measurement results corresponding to the m pieces of sensing measurement result validity are measurement results of performing sensing measurement on a target signal received by the first device.

### BRIEF DESCRIPTION OF DRAWINGS

FIG. 1 is a block diagram of a wireless communication system to which the embodiments of this application are applicable;

FIG. 2 is a block diagram of wireless sensing according to an embodiment of this application;

FIG. 3 is another block diagram of wireless sensing according to an embodiment of this application;

FIG. 4 is a flowchart of an indication information sending method according to an embodiment of this application;

FIG. 5 is a flowchart of an indication information receiving method according to an embodiment of this application;

FIG. 6 is a schematic diagram of an indication information sending method according to an embodiment of this application;

FIG. 7 is a block diagram of an indication information sending apparatus according to an embodiment of this application;

FIG. 8 is a block diagram of an indication information receiving apparatus according to an embodiment of this application;

FIG. 9 is a block diagram of a communication device according to an embodiment of this application;

FIG. 10 is a block diagram of another communication device according to an embodiment of this application; and

FIG. 11 is a block diagram of another communication device according to an embodiment of this application.

### DETAILED DESCRIPTION

The following describes the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first,” “second,” and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (New Radio, NR) system for example purposes, and NR terms are used in most of the following descriptions. These technologies can also be applied to applications other than an NR system application, such as a 6th generation (6G) communication system.

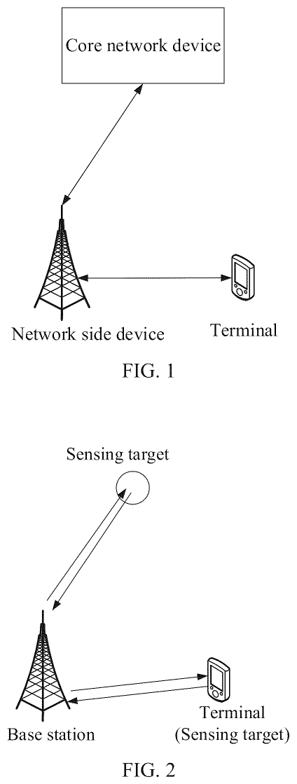

FIG. 1 is a block diagram of a wireless communication system to which the embodiments of this application can be applied. The wireless communication system includes a terminal, a network side device, and a core network device.

In the embodiments of this application, the terminal may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a personal computer, a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal is not limited in the embodiments of this application.

The network side device may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), an Access Point (AP), a relay, a Reconfigurable Intelligence Surface (RIS), or another appropriate term in the field. As long as a same technical effect is achieved, the base station is not limited to a specified technical term. It should be noted that, in this application, only a base station in an NR system is used as an example, and a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

In the embodiments of this application, a network side device and a terminal have a sensing capability, and send and receive a radio signal to sense information such as a direction, a distance, and/or a speed of a target object, or detect, track, identify, or image a target object, a target event, a target environment, or the like. For example, in some scenarios or implementations, sensing categories may be shown in the following Table 1:

TABLE 1

| Wireless sensing | | |
|---|---|---|
| category | Sensing function | Application scenario |
| Macro sensing | Weather, air quality, and the like | Meteorology, agriculture, and life services |
| | Stream of traffic (intersections) | Smart city, intelligent transportation, and |
| | and stream of people (subway | business services |
| | entrances) | |
| | Animal activities, migration, and | Animal husbandry, ecological environment |
| | the like | protection, and the like |
| | Target tracking, ranging, velocity | Many application scenarios for conventional |
| | measurement, contours, and the | radars |
| | like | |
| | Three-dimensional map | Intelligent driving, navigation, and smart city |
| | construction | |
| Fine sensing | Action posture recognition | Intelligent interaction of smartphones, |
| | | games, and smart home |
| | Heartbeat/breathing, and the like | Health and medical care |
| | Imaging, material detection, and | Security check, industry, and the like. |
| | the like | |

It should be noted that the sensing categories shown in the foregoing Table 1 is merely an example for description, and a sensing measurement category is not limited in the embodiments of this application.

In addition, the embodiments of this application may be applied to an integrated communication and sensing application scenario in integration of communication and a radar. In this scenario, a joint design includes spectrum coexistence, that is, two systems work independently, and information exchange may be allowed to reduce mutual interference. In the case of sharing at a receive end, transmit ends of the two systems send respective signal waveforms, and the waveforms of the two systems need to be orthogonal, thus not affecting respective receiving and detection; in the case of sharing at a transmit end, the transmit end transmits a joint waveform of a radar and communication; and in the case of sharing at a transmit end and a receive end, resources are shared on a transmit end and a receive end of the two systems, and similarly, a joint waveform or waveforms in an orthogonal relationship need to be used. It should be noted that the foregoing integrated communication and sensing application scenario in integration of communication and a radar is an example of application scenarios of the embodiments of this application, and a corresponding scenario is not limited in the embodiments of this application.

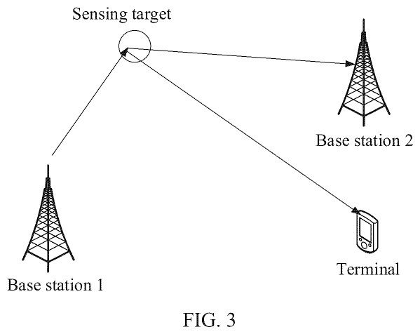

In the embodiments of this application, during sensing, sensing may be performed based on a single-station mode, that is, transmit/receive co-location. A transmit end transmits a sensing signal, and then receives and analyzes an echo signal to extract a sensing parameter. For example, as shown in FIG. 2, a base station is used as a transmit end and a receive end of the sensing signal, and a terminal or another object is used as a sensing target. In some implementations, sensing is performed based on a dual-station/multi-station mode, that is, transmission and receiving do not use a same address. A transmit end transmits a sensing signal, and another receive end receives and analyzes the sensing signal to extract a sensing parameter. For example, as shown in FIG. 3, a base station 1 is used as a sensing signal transmit end, and a terminal or a base station 2 is used as a sensing signal receive end.

In the embodiments of this application, a communication system may jointly send a modulation symbol that carries information and a pilot symbol that is used for channel estimation, and focuses on decoding performance. A channel estimation algorithm of the communication system only needs to estimate a composite channel that has finite unknown parameters, and generally an optimization objective is to improve a throughput and transmission reliability. Performance indicators that are concerned are usually spectrum efficiency, a channel capacity, a Signal-to-Noise Ratio (SNR), a Signal to Interference plus Noise Ratio (SINR), a Bit Error Ratio (BER), a BLock Error Rate (BLER), a Symbol Error Rate (SER), and the like. However, an information carrying problem is not considered in a signal sending process of a sensing system. Generally, an optimized or unmodulated transmit signal is used, and a change, that is, a response characteristic, that is brought by a sensing target to a transmit signal is focused. Generally, an optimization target is to improve parameter estimation precision. A performance measurement indicator may be a fuzzy function, a Cramer-Rao lower bound, a root mean square error, mutual information, a rate distortion function, a radar estimation rate, a Welch lower bound, and some indicators associated with a sensing scenario and a requirement.

In the embodiments of this application, in some scenarios or implementations, both a wireless communication signal and a wireless sensing signal are supported, and an integrated communication and sensing function design is implemented by using an integrated communication and sensing means such as a signal joint design and/or hardware sharing, so that a sensing capability or a sensing service is provided while information transmission is performed. In this way, cost saving, device size reducing, device power consumption reducing, spectrum efficiency improving, reducing of mutual interference between communication and sensing, and system performance improving can be achieved by means of integrated communication and sensing.

In addition, integrated sensing and communication may include but is not limited to at least one of the following:
a same network provides a communication service and a sensing service;
a same terminal provides a communication service and a sensing service;
a same spectrum provides a communication service and a sensing service; and
an integrated sensing and communication service is completed in same radio transmission, that is, a joint design of a communication signal and a sensing signal.

In the embodiments of this application, for a communication and sensing fusion scenario or an integrated sensing and communication scenario, a dedicated sensing signal may be used for sensing measurement, or a communication signal, such as data and/or a pilot, may be reused. For use of a sensing measurement signal, a sending party may instruct a receiving party, for example, a base station instructs a terminal to use which type of signal for sensing measurement.

With reference to the accompanying drawings, the following describes in detail an indication information sending method and apparatus, an indication information receiving method and apparatus, a device, and a storage medium provided in the embodiments of this application by using some embodiments and application scenarios thereof.

Referring to FIG. 4, FIG. 4 is a flowchart of an indication information sending method according to an embodiment of this application. As shown in FIG. 4, the method includes the following steps:

Step 401: A first device sends first indication information to a second device, where the first indication information is used to indicate m pieces of sensing measurement result validity and n pieces of communication data reception correctness, m and n are positive integers, and m+n>2, where
m sensing measurement results corresponding to the m pieces of sensing measurement result validity are measurement results of performing sensing measurement on a target signal received by the first device.

The first device may be a network side device or a terminal, and the second device may be a sensing network function and/or a sensing network element in a core network, or may be a network side device or a terminal.

In this embodiment of this application, the target signal may be a communication signal such as a reference signal, a synchronization signal, or a data signal, or the target signal may be a dedicated sensing signal such as a radar pulse signal or a Frequency Modulated Continuous Wave (FMCW) signal.

The target signal may be received and sent in the following several manners:
a network side device A sends a target signal, and the network side device B receives the target signal, where the network side device B serves as the first device, and the network side device A serves as the second device, or at least one of the network side device A and the network side device B serves as the first device, and the core network serves as the second device;
a network side device sends a target signal, and a terminal receives the target signal, where the terminal serves as the first device, and the network side device serves as the second device, or at least one of the network side device and the terminal serves as the first device, and the core network serves as the second device;
a network side device performs self-transmitting and self-receiving, where the network side device serves as the first device, and the core network serves as the second device;
a terminal performs self-transmitting and self-receiving, where the terminal serves as the first device, and a network side device serves as the second device, or the terminal serves as the first device, and the core network serves as the second device;
a terminal performs sending and a network side device performs receiving, where the network side device serves as the first device, and the core network serves as the second device; and
a terminal A performs sending and a terminal B performs receiving, where the terminal B serves as the first device, and the terminal A serves as the second device, or the terminal A or the terminal B serves as the first device, and an access network side device of the terminal A or the terminal B serves as the second device, or the terminal A or the terminal B serves as the first device, and the core network serves as the second device.

It should be noted that the target signal in this embodiment of this application may be sent by a plurality of devices, and the target signal may be received by a plurality of devices.

The first indication information may explicitly or implicitly indicate the m pieces of sensing measurement result validity and the n pieces of communication data reception correctness.

The m pieces of sensing measurement result validity may be m sensing measurement result validity indications. Each piece of sensing measurement result validity is used to indicate validity or invalidity of a corresponding sensing measurement result, and each sensing measurement result or each sensing measurement result validity indication is associated with one or more sensing measurements, where one sensing measurement may be measurement based on one or more target signals.

In addition, a criterion for whether a sensing measurement result is valid or invalid may be configured by a network device and/or defined by a protocol, or a criterion for whether a sensing measurement result is valid or invalid is determined by being associated with a sensing measurement quantity or a sensing requirement or a sensing service.

The n pieces of communication data reception correctness may be n communication data reception correctness indications, and each indication represents reception correctness of one or more data transmissions. For example, n pieces of communication data reception confirmation information are n ACKnowledgements (ACK) or n Negative ACKnowledgement (NACK) of receiving communication data, or a total quantity of ACKs and NACKs is n.

In this embodiment of this application, through the foregoing steps, the first device may indicate the m pieces of sensing measurement result validity and the n pieces of communication data reception correctness to the second device, so as to implement sensing measurement, thereby improving working performance of the device. In addition, because m+n>2, a plurality of feedback results can be indicated at one time, so as to reduce transmission overheads.

In addition, in this embodiment of this application, content indicated by the first indication information further includes further processing or signal configuration adjustment on a sensing measurement result by the second device that receives the first indication information, so as to improve sensing measurement performance. In some implementations, content indicated by the first indication information may assist a party that receives a sensing measurement result to further process the sensing measurement result or adjust a configuration of a sensing measurement signal, so as to obtain better sensing measurement performance.

In an implementation, the first indication information includes an indication bit, and the indication bit is at least one bit indicating the m pieces of sensing measurement result validity and the n pieces of communication data reception correctness.

The indication bit may indicate the m pieces of sensing measurement result validity, and n bits indicate the n pieces of communication data reception correctness through joint coding or independent coding.

In an implementation, the indication bit is m+n bits, where
m bits indicate the m pieces of sensing measurement result validity, and n bits indicate the n pieces of communication data reception correctness; or
2x bits in the m+n bits indicate x pieces of sensing measurement result validity and x pieces of communication data reception correctness through joint coding; and in a case that x is less than m, m−x bits in the m+n bits indicate m−x pieces of sensing measurement result validity, and in a case that x is less than n, n−x bits in the m+n bits indicate n−x pieces of sensing measurement result validity, where x is a positive integer, x is less than or equal to m, and x is less than or equal to n.

The m bits and the n bits respectively indicate the m pieces of sensing measurement result validity and the n pieces of communication data reception correctness. Joint coding or independent coding may be adopted, where bit rates in the independent coding may be different, so that different priority or importance requirements can be met. In addition, that the m bits indicate the m pieces of sensing measurement result validity may be: for each 1 bit in the m bits, “0” indicates that a sensing measurement result is invalid, and “1” indicates that a sensing measurement result is valid; and the n bits indicate the n pieces of communication data reception correctness, that is, indicates n ACKs/NACKs. For example, for each of the n bits, “0” indicates that communication data is incorrectly received (NACK), and “1” indicates that communication data is correctly received (ACK).

The x pieces of sensing measurement result validity and the x pieces of communication data reception correctness may be that there are x associated sensing measurement result validity and communication data reception correctness indications in the m pieces of sensing measurement result validity and the n pieces of communication data reception correctness. In this case, the x pieces of sensing measurement result validity and the x pieces of communication data reception correctness may be indicated by using 2x bits through joint coding. Each associated 2 bits in the 2x bits jointly indicate sensing measurement result validity and communication data reception correctness through joint coding, that is, each 2 bits represent four states. In particular, for example, if a case that communication data is incorrectly received but a sensing measurement result is valid does not exist, a value of 2 bits corresponding to the state (communication data is incorrectly received and a sensing measurement result is valid) may be Reserved. For example, as shown in Table 2 below:

TABLE 2

| | Whether communication | Whether a sensing |
|---|---|---|
| Values of | data is correctly | measurement result |
| 2 bits | demodulated | is valid |
| 00 | No | No |

| | |
|---|---|
| 01 | Reserved |

| | | |
|---|---|---|
| 10 | Yes | No |
| 11 | Yes | Yes |

Remaining m−x bits and n−x bits may respectively indicate sensing measurement result validity and communication data reception correctness. When there are the following cases: x=m, x=n, and x=m=n, there may be no bit for independently indicating sensing measurement result validity and/or communication data reception correctness. That is, in a case that m−x bits in the m+n bits indicate m−x pieces of sensing measurement result validity, and in a case that x is less than n, n−x bits in the m+n bits indicate n−x pieces of sensing measurement result validity.

In this implementation, sensing measurement result validity and communication data reception correctness can be accurately indicated by using m+n bits.

In an implementation, the indication bit is 2 bits, a first value of a first bit in the 2 bits indicates that at least one of the m pieces of sensing measurement result validity is invalid, and a second value of the first bit indicates that all the m pieces of sensing measurement result validity are valid; and a first value of a second bit in the 2 bits indicates that at least one of the n pieces of communication data reception correctness is incorrect, and a second value of the second bit in the 2 bits indicates that all the n pieces of communication data reception correctness are correct.

In this implementation, 1 bit may be used as a logic AND result of m bits used to indicate the m pieces of sensing measurement result validity. For example, “0” indicates that at least one of the m sensing measurement results is invalid, and “1” indicates that all the m sensing measurement results are valid. The other 1 bit is used as a logic AND result of n bits used to indicate the n pieces of communication data reception correctness. For example, “0” indicates that at least one of the n communication data reception correctness indications is a reception incorrect indication (NACK), and “1” indicates that all the n communication data reception correctness indications are reception correct indications (ACK).

In this implementation, signaling overheads can be reduced by using 2 bits.

In an implementation, the indication bit is 1 bit, a second value of the first bit indicates that all the m pieces of sensing measurement result validity are valid, all the n pieces of communication data reception correctness are correct, and a first value of the 1 bit indicates at least one of the following:
at least one of the m pieces of sensing measurement result validity is invalid, and at least one of the n pieces of communication data reception correctness is incorrect.

In this implementation, 1 bit is used as a logic AND result of m bits used to indicate the m pieces of sensing measurement result validity and n bits used to indicate communication data reception correctness. For example, “O” indicates that at least one of the m sensing measurement results is invalid and/or at least one of the n communication data reception correctness indications is a reception incorrect indication (NACK), and “1” indicates that all the m sensing measurement results are valid and all the n communication data reception correctness indications are reception correct indications (ACK).

In this implementation, signaling overheads can be reduced by using 1 bit.

In an implementation, the indication bit is m+n−x bits, where x bits in the m+n−x bits respectively indicate x joint indications, and each joint indication is a joint indication of one piece of sensing measurement result validity and one piece of communication data reception correctness; and in a case that x is less than m, m−x bits in the m+n−x bits indicate m−x pieces of sensing measurement result validity, and in a case that x is less than n, n−x bits in the m+n−x bits indicate n−x pieces of sensing measurement result validity, where x is a positive integer, x is less than or equal to m, and x is less than or equal to n.

In this implementation, there may be x associated sensing measurement result validity and communication data reception correctness indications in the m sensing measurement result validity indications and the n communication data reception correctness indications. Each bit in the x bits is used to indicate a 2-bit logic AND logical result of associated sensing measurement result validity and communication data reception correctness. For example, each of the x bits is used to indicate associated sensing measurement result validity and communication data reception correctness. For example, “O” indicates that communication data is incorrectly received (NACK) or a sensing measurement result is invalid, and “1” indicates that communication data is correctly received (ACK) and a sensing measurement result is valid.

Remaining m−x bits and n−x bits respectively indicate sensing measurement result validity and communication data reception correctness. When the following cases exist: x=m<n, x=n<m, and x=m=n, there may be no bit for independently indicating sensing measurement result validity and/or communication data reception correctness. That is, in a case that x is less than m, m−x bits in the m+n−x bits indicate m−x pieces of sensing measurement result validity, and in a case that x is less than n, n−x bits in the m+n−x bits indicate n−x pieces of sensing measurement result validity.

In this implementation, signaling overheads can be reduced by using m+n−x bits.

In an implementation, the indication bit includes x bit groups, the x bit groups respectively indicate x joint indications, and each joint indication is a joint indication of one piece of sensing measurement result validity and one piece of communication data reception correctness, where
the x bit groups include at least one of the following:
a bit group of 1 bit, where the bit group of 1 bit indicates that communication data reception correctness in a corresponding joint indication is incorrect and sensing measurement result validity is invalid; and
a bit group of 2 bits, where a 1-bit indication in the bit group of 2 bits indicates that communication data reception correctness in a corresponding joint indication is correct, and the other 1 bit indicates sensing measurement result validity in the corresponding joint indication; and
in a case that x is less than m, the indication bit further includes m−x bits indicating m−x pieces of sensing measurement result validity; and
in a case that x is less than n, the indication bit further includes n−x bits indicating n−x pieces of sensing measurement result validity, where
x is a positive integer, x is less than or equal to m, and x is less than or equal to n.

In this implementation, there are x associated sensing measurement result validity and communication data reception correctness indications in the m sensing measurement result validity indications and the n communication data reception correctness indications, and the x sensing measurement result validity indications perform indication based on sensing measurement result validity of communication data. Specifically, in a case that the target signal is a communication data signal, it may be determined to use 1 bit or 2 bits in each bit group based on communication data reception correctness. For example:

When communication data is incorrectly received, 1 bit is used for indication, where “0” indicates that communication data is incorrectly received (NACK) and a sensing measurement result is invalid; or
when communication data is correctly received, 2 bits are used for indication, where 1 bit “1” indicates that communication data is correctly received (ACK), and the other 1 bit is used to indicate whether a sensing measurement result is valid.

In addition, in this implementation, a communication data reception correctness indication and a sensing measurement result validity indication are independently coded, and the communication data reception correctness indication is located front.

In this implementation, 1 bit or 2 bits may be flexibly used to reduce signaling overheads.

In an implementation, the indication bit is m×u+n bits, where m×u bits respectively indicate levels of the m pieces of sensing measurement result validity, and n bits indicate the n pieces of communication data reception correctness.

The foregoing sensing measurement result validity level may be that different levels correspond to different signal quality, and the signal quality may include at least one of an SNR, a Reference Signal Received Power (RSRP), a Received Signal Strength Indication (RSSI), a signal clutter ratio, and the like; or the foregoing sensing measurement result validity level may be that different levels correspond to different sensing performance indicators; or the foregoing sensing measurement result validity level may be that different levels correspond to different measurement result validity thresholds. For example, it is assumed that there are two thresholds, and three levels are included, where one level represents being invalid, another level represents being valid for a first threshold but being invalid for a second threshold, and one another level represents being valid for the second threshold (it is assumed that the second threshold has a higher requirement).

In this implementation, sensing measurement result validity may be classified into different levels, so that a feedback effect of the sensing measurement result validity can be improved, and the m pieces of sensing measurement result validity and the n pieces of communication data reception correctness may be respectively by using m×u bits and n bits.

In an implementation, the first indication information is further used to indicate at least one of the following:
a sensing measurement result invalidity cause; and
a parameter configuration of a target signal.

The sensing measurement result invalidity cause may be cause information of a sensing measurement result indicated as invalid in the m pieces of sensing measurement result validity.

The parameter configuration of the target signal may be a parameter configuration that is of the target signal and that is recommended or expected by the first device, and may be a parameter configuration of the target signal corresponding to a sensing measurement result indicated as invalid in the m pieces of sensing measurement result validity. The parameter configuration may be used to improve validity of a sensing measurement result corresponding to the target signal.

In this implementation, at least one of the invalidity cause and the parameter configuration is fed back, so that the second device that receives the first information can further process a sensing measurement result or adjust a signal configuration, so as to improve sensing measurement performance. In some implementations, at least one of the invalidity cause and the parameter configuration may assist a party that receives a sensing measurement result to further process the sensing measurement result, or adjust a configuration of a sensing measurement signal, so as to obtain better sensing measurement performance.

In some implementations, the sensing measurement result invalidity cause is at least one of the following:
quality of the target signal detected by the first device does not reach a threshold requirement;
a sensing measurement result obtained by the first device does not meet a sensing requirement;
the first device does not correctly demodulate data in a case that the target signal is a communication data signal; and
the first device does not obtain a sensing measurement result when a feedback time point of the first indication information arrives.

That quality of the target signal detected by the first device does not reach a threshold requirement may be that at least one of an SNR, an RSRP, an RSSI, and a signal clutter ratio threshold of the target signal detected by the first device does not meet the threshold requirement. In addition, in a measurement process, a receive end may first measure at least one of an SNR, an RSRP, an RSSI, and a signal clutter ratio, and then measure a specific sensing measurement quantity if a threshold is reached.

That a sensing measurement result obtained by the first device does not meet a sensing requirement may be that a sensing performance indicator corresponding to the sensing measurement result obtained by the first device through calculation does not meet the requirement. For example, a sensing SNR is less than a preset threshold.

That the first device does not correctly demodulate data may be that, during sensing based on communication data, demodulation is performed first and then a sensing parameter is estimated, and if communication demodulation is incorrect, a sensing measurement result is affected and becomes unreliable, that is, the sensing measurement result is invalid.

That the first device does not obtain a sensing measurement result when a feedback time point of the first indication information arrives may be that a receive end fails to obtain a sensing measurement result when the feedback time point arrives, for example, sensing measurement result processing expires.

In some implementations, the parameter configuration includes at least one of the following:
a waveform, a subcarrier spacing, a guard interval, a bandwidth, burst (burst) duration, a time domain spacing, a transmit signal power, a signal format, a signal direction, a time resource, a frequency domain resource, and a quasi co-location (Quasi co-location, QCL) relationship.

The waveform may include Orthogonal Frequency Division Multiplex (OFDM), Single-Carrier Frequency-Division Multiple Access (SC-FDMA) SC-FDMA, Orthogonal Time Frequency Space (OTFS), a Frequency Modulated Continuous Wave (FMCW), a pulse signal, or the like.

The subcarrier spacing may be a subcarrier spacing 30 KHz, 15 KHz, or the like in an OFDM system.

The guard interval may be a time interval from a moment at which sending of a signal ends to a moment at which a latest echo signal of the signal is received. The parameter is proportional to a maximum sensing distance, for example, may be obtained through calculation by using 2dmax/c, where dmax is the maximum sensing distance (belonging to a sensing requirement). For a self-transmitting and self-receiving sensing signal, dmax represents a maximum distance between a sensing signal transmitting/receiving point and a signal transmit point. In some cases, an OFDM signal Cyclic Prefix (CP) may function as a minimum guard interval. In addition, c is an optical speed.

The bandwidth may be inversely proportional to distance resolution, for example, may be obtained by using c/2/delta_d, where delta_d is the distance resolution (belonging to a sensing requirement).

The burst duration may be inversely proportional to a rate resolution (belonging to a sensing requirement). The parameter is a time span of a sensing signal, and is mainly used to calculate a Doppler frequency offset. This parameter may be calculated by using c/2/delta_v/fc, where delta_v is speed resolution, and fc is a signal carrier frequency or a signal center frequency.

The time domain interval may be obtained through calculation by using c/2/fc/v_range, where v_range is a maximum rate minus a minimum speed (belonging to a sensing requirement). The parameter is a time interval between two adjacent sensing signals.

The transmit signal power may be a value obtained at intervals of 2 dBm from −20 dBm to 23d Bm. Certainly, this is merely an example, and may be specifically set according to an actual requirement.

The signal format may be information about a Sounding Reference Signal (SRS), a Demodulation Reference Signal (DMRS), a Positioning Reference Signal (PRS), or another predefined signal, and a related sequence format.

The signal direction may be direction or beam information of a sensing signal.

The time resource may include a slot index or a symbol index of a slot in which a sensing signal is located. There are two types of time resources: One is a one-time time resource, for example, one symbol is used to send an omnidirectional target signal; and the other is a non-one-time time resource, for example, a plurality of groups of periodic time resources or discontinuous time resources (which may include a start time and an end time), each group of periodic time resources are used to send sensing signals in a same direction, and beam directions of periodic time resources in different groups are different.

The frequency resource may include a center frequency, a bandwidth, a Resource Block (RB), a subcarrier, or the like of a sensing signal.

The QCL relationship may include: a QCL between each of a plurality of resources included in a sensing signal and a Synchronization Signal Block (SSB), where the QCL includes Type A, B, C, or D.

In this implementation, the second device can adjust a configuration of a sensing measurement signal by using the foregoing parameter configuration, so as to obtain better sensing measurement performance.

In an implementation, the first indication information is further used to indicate at least one of the following:
identifier information of a target signal associated with a sensing measurement result;
sensing measurement identifier information;
a sensing measurement result; and
feedback information of the first indication information.

The identifier information of the target signal associated with the sensing measurement result may include identifier information of target signals associated with sensing measurement results corresponding to the m pieces of sensing measurement result validity.

The sensing measurement identifier information may include sensing measurement identifier information respectively corresponding to the m pieces of sensing measurement result validity.

The sensing measurement result may include sensing measurement results respectively corresponding to the m pieces of sensing measurement result validity.

The identifier information of the target signal associated with the sensing measurement result indicates which one or more target signals corresponding to sensing measurement result validity are indicated by the sensing measurement result validity indication information. In this way, sensing measurement result validity of a specific target signal can be indicated, so as to implement accurate indication.

The sensing measurement identifier information may indicate which sensing measurement corresponding to sensing measurement result validity is indicated by the sensing measurement result validity indication information, and the sensing measurement may be measurement based on one or more target signals. In this way, sensing measurement result validity of specific sensing measurement can be indicated, so as to implement accurate indication.

Indicating the sensing measurement result may be indicating a specific sensing measurement result.

The feedback information of the first indication information may include at least one of the following:
a total quantity of bits of the first indication information;
a quantity of valid sensing measurement results corresponding to the first indication information;
a quantity of invalid sensing measurement results corresponding to the first indication information;
a quantity of sensing measurement results indicated in the first indication information;
a quantity of invalidity causes indicated in the first indication information;
a quantity of recommended parameter configurations of a target signal that are indicated in the first indication information;
a quantity of bits for indicating a sensing measurement result in the first indication information;
a quantity of bits for indicating an invalidity cause in the first indication information; and
a quantity of bits for indicating a recommended target signal parameter configuration in the first indication information.

Through the feedback information, the second device can accurately obtain content indicated by the first indication information.

In an implementation, in a case that a first piece of sensing measurement result validity indicated in the first indication information is valid, the first indication information indicates a first sensing measurement result, and the first piece of sensing measurement result validity is one of the m pieces of sensing measurement result validity;
and/or
in a case that a second sensing measurement result is valid, the first indication information indicates at least one of the following:
sensing measurement result validity of the second sensing measurement result;
identifier information of a target signal associated with the second sensing measurement result;
sensing measurement identifier information of the second sensing measurement result; and
the second sensing measurement result, where
the second sensing measurement result is one of the m sensing measurement results;
and/or
in a case that a third piece of sensing measurement result validity indicated by the first indication information is invalid, the first indication information indicates at least one of the following:
indication information of an invalidity cause of a third sensing measurement result; and
a parameter configuration of a target signal, where
the third piece of sensing measurement result validity is one of the m pieces of sensing measurement result validity;
and/or
in a case that a fourth sensing measurement result is invalid, the first indication information indicates at least one of the following:
sensing measurement result validity of the fourth sensing measurement result;
indication information of an invalidity cause of the fourth sensing measurement result; and
a parameter configuration of a target signal, where
the fourth sensing measurement result is one of the m sensing measurement results;
and/or
in a case that a fifth sensing measurement result is valid, the first indication information does not indicate related information of the fifth sensing measurement result, where
the fifth sensing measurement result is one of the m sensing measurement results;
and/or
in a case that a sixth sensing measurement result is valid, the first indication information does not indicate related information of the sixth sensing measurement result, where
the sixth sensing measurement result is one of the m sensing measurement results.

In this implementation, the first indication information includes the first sensing measurement result only when sensing measurement result validity indication information of a sensing measurement result in the first indication information indicates that a sensing measurement result is valid, so as to reduce signaling overheads.

Only when a sensing measurement result is valid, the first indication information sent by the second device to the first device includes a sensing measurement result validity indication of the sensing measurement result and/or the sensing measurement result and/or identifier information of a target signal associated with the sensing measurement result and/or sensing measurement identifier information, and when a measurement result is invalid, the first indication information does not include related feedback information of the first sensing measurement result, so as to reduce signaling overheads.

Only when a sensing measurement result is invalid, the first indication information sent by the second device to the first device includes a sensing measurement result validity indication of the sensing measurement result and/or a sensing measurement result invalidity cause and/or a recommended target signal parameter configuration, and when a measurement result is valid, the first indication information does not include related feedback information of the sensing measurement result, so as to reduce signaling overheads.

Only when sensing measurement result validity indication information of a sensing measurement result in the first indication information indicates that the sensing measurement result is invalid, the first indication information includes a sensing measurement result invalidity cause of the sensing measurement result and/or a recommended target signal parameter configuration, so as to reduce signaling overheads.

In an implementation, before the sending, by a first device, first indication information to a second device, the method further includes:
receiving, by the first device, second indication information sent by the second device, where the second indication information is used to indicate at least one of the following:
whether sensing measurement result validity needs to be fed back;
a feedback configuration of sensing measurement result validity and communication data reception correctness;
a criterion for determining sensing measurement result validity;
a sensing measurement quantity;
a sensing requirement; and
a sensing service.

Whether the sensing measurement result validity needs to be fed back may indicate whether validity feedback needs to be performed on all or a part of sensing measurement results within a period of time (for example, from a current moment to a termination moment of a sensing service).

The feedback configuration of the sensing measurement result validity and the communication data reception correctness may indicate how to feed back the sensing measurement result validity and the communication data reception correctness, for example, may include at least one of the following:
a feedback timing;
a feedback resource;
a feedback manner;
a joint feedback configuration or indication; and
a format of the first indication information.

The feedback timing may represent a time length between a feedback time point and a reference time point (for example, a sending/ending time of a target signal or control information of a target signal).

The feedback resource may indicate a Physical Uplink Control CHannel (PUCCH) and/or a Physical Uplink Shared CHannel (PUSCH), which is equivalent to a specific time-frequency domain resource corresponding to the first indication information.

The feedback manner may include:
an event trigger feedback, for example, the first indication information is sent only when a sensing measurement result is invalid or valid as described in the foregoing implementation;
a periodical trigger feedback, for example, the first device sends the first indication information according to a specific period; and
a message trigger feedback, for example, the first device sends the first indication information according to an indication message of the second device.

The joint feedback configuration or indication may include:
whether a joint feedback of sensing measurement result validity and communication data reception correctness indications is allowed; and
a feedback priority of sensing measurement result validity and communication data reception correctness indications may be associated with a feedback delay requirement, or a feedback priority of sensing measurement result validity and communication data reception correctness indications may be associated with a sensing service/communication service priority, where the priority may affect the format of the first indication information, for example, an order of a sensing measurement result validity feedback and a communication data reception correctness feedback, and a bit rate during independent coding.

The criterion for determining sensing measurement result validity includes at least one of the following:
whether quality of the target signal detected by the first device reaches a threshold requirement;
whether a sensing measurement result obtained by the first device meets a sensing requirement;
whether the first device correctly demodulates data in a case that the target signal is a communication data signal; and
whether the first device obtains a sensing measurement result when a feedback time point of the first indication information arrives.

For the criterion for determining sensing measurement result validity, refer to the corresponding descriptions of the foregoing implementation. Details are not described herein again. In addition, target signal quality threshold information and sensing measurement result performance indicator requirement information may be further included.

At least one of the sensing measurement quantity, the sensing requirement, and the sensing service may be used to indirectly indicate the criterion for determining sensing measurement result validity by the first device. For example, the criterion for determining whether a sensing measurement result is valid or invalid as described in the foregoing implementation may be associated with at least one of the sensing measurement quantity, the sensing requirement, and the sensing service.

In an implementation, before the sending, by a first device, first indication information to a second device, the method further includes:
receiving, by the first device, third indication information sent by the second device, where the third indication information is used to indicate at least one of the following:
indication information of whether sensing measurement is allowed based on a communication data symbol;
configuration information of a communication data signal for sensing measurement; and
sensing Quality of Service (QOS) information.

The configuration information of the communication data signal for sensing measurement may be a time domain resource configuration, a frequency domain resource configuration, or the like of the communication data signal.

The indication information of whether sensing measurement is allowed based on a communication data symbol may improve accuracy of sensing measurement by the first device, and the configuration information of the communication data signal for sensing measurement may also improve accuracy of sensing measurement by the first device.

The sensing QoS information may include at least one of the following:
a priority of a sensing/integrated sensing and communication service, a requirement for a sensing resolution, a requirement for sensing precision or a sensing error, a sensing delay budget, a requirement for a maximum sensing range, a requirement for a continuous sensing capability, a requirement for a sensing update frequency, a detection probability, a false alarm probability, a requirement for a missed detection probability, and the like.

In this way, the first device may determine, according to the QoS information, a specific sensing signal or data and a specific data symbol to be used, thereby improving flexibility of sensing measurement.

In this embodiment of this application, a first device sends first indication information to a second device, where the first indication information is used to indicate m pieces of sensing measurement result validity and n pieces of communication data reception correctness, m and n are positive integers, and m+n>2, where m sensing measurement results corresponding to the m pieces of sensing measurement result validity are measurement results of performing sensing measurement on a target signal received by the first device. In this way, the first device the m pieces of sensing measurement result validity and the n pieces of communication data reception correctness to the second device, to implement sensing measurement.

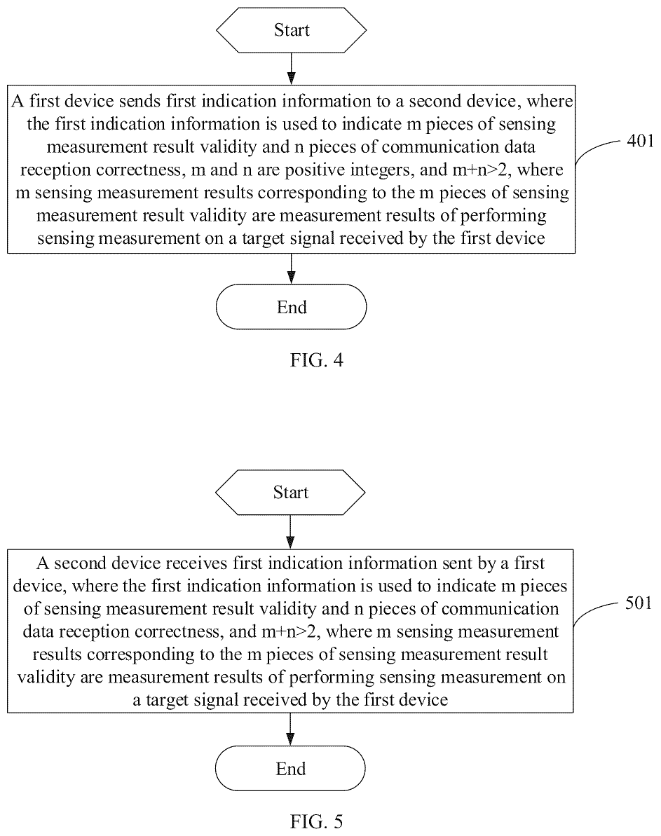

Referring to FIG. 5, FIG. 5 is a flowchart of an indication information receiving method according to an embodiment of this application. As shown in FIG. 5, the method includes the following steps:

Step 501: A second device receives first indication information sent by a first device, where the first indication information is used to indicate m pieces of sensing measurement result validity and n pieces of communication data reception correctness, and m+n>2, where
m sensing measurement results corresponding to the m pieces of sensing measurement result validity are measurement results of performing sensing measurement on a target signal received by the first device.

In some implementations, the first indication information includes an indication bit, and the indication bit is at least one bit indicating the m pieces of sensing measurement result validity and the n pieces of communication data reception correctness.

In some implementations, the indication bit is m+n bits, where
m bits indicate the m pieces of sensing measurement result validity, and n bits indicate the n pieces of communication data reception correctness; or
2x bits in the m+n bits indicate x pieces of sensing measurement result validity and x pieces of communication data reception correctness through joint coding; and in a case that x is less than m, m−x bits in the m+n bits indicate m−x pieces of sensing measurement result validity, and in a case that x is less than n, n−x bits in the m+n bits indicate n−x pieces of sensing measurement result validity, where x is a positive integer, x is less than or equal to m, and x is less than or equal to n.

In some implementations, the indication bit is 2 bits, a first value of a first bit in the 2 bits indicates that at least one of the m pieces of sensing measurement result validity is invalid, and a second value of the first bit indicates that all the m pieces of sensing measurement result validity are valid; and a first value of a second bit in the 2 bits indicates that at least one of the n pieces of communication data reception correctness is incorrect, and a second value of the second bit in the 2 bits indicates that all the n pieces of communication data reception correctness are correct;
or
the indication bit is 1 bit, a second value of the first bit indicates that all the m pieces of sensing measurement result validity are valid, all the n pieces of communication data reception correctness are correct, and a first value of the 1 bit indicates at least one of the following:
at least one of the m pieces of sensing measurement result validity is invalid, and at least one of the n pieces of communication data reception correctness is incorrect.

In some implementations, the indication bit is m+n−x bits, where x bits in the m+n−x bits respectively indicate x joint indications, and each joint indication is a joint indication of one piece of sensing measurement result validity and one piece of communication data reception correctness; and in a case that x is less than m, m−x bits in the m+n−x bits indicate m−x pieces of sensing measurement result validity, and in a case that x is less than n, n−x bits in the m+n−x bits indicate n−x pieces of sensing measurement result validity, where x is a positive integer, x is less than or equal to m, and x is less than or equal to n.

In some implementations, the indication bit includes x bit groups, the x bit groups respectively indicate x joint indications, and each joint indication is a joint indication of one piece of sensing measurement result validity and one piece of communication data reception correctness, where
the x bit groups include at least one of the following:
a bit group of 1 bit, where the bit group of 1 bit indicates that communication data reception correctness in a corresponding joint indication is incorrect and sensing measurement result validity is invalid; and
a bit group of 2 bits, where a 1-bit indication in the bit group of 2 bits indicates that communication data reception correctness in a corresponding joint indication is correct, and the other 1 bit indicates sensing measurement result validity in the corresponding joint indication; and
in a case that x is less than m, the indication bit further includes m−x bits indicating m−x pieces of sensing measurement result validity; and
in a case that x is less than n, the indication bit further includes n−x bits indicating n−x pieces of sensing measurement result validity, where
x is a positive integer, x is less than or equal to m, and x is less than or equal to n.

In some implementations, the indication bit is m×u+n bits, where m×u bits respectively indicate levels of the m pieces of sensing measurement result validity, and n bits indicate the n pieces of communication data reception correctness.

In some implementations, the first indication information is further used to indicate at least one of the following:
a sensing measurement result invalidity cause; and
a parameter configuration of a target signal.

In some implementations, the sensing measurement result invalidity cause is at least one of the following:
quality of the target signal detected by the first device does not reach a threshold requirement;
a sensing measurement result obtained by the first device does not meet a sensing requirement;
the first device does not correctly demodulate data in a case that the target signal is a communication data signal; and
the first device does not obtain a sensing measurement result when a feedback time point of the first indication information arrives.

In some implementations, the parameter configuration includes at least one of the following:
a waveform, a subcarrier spacing, a guard interval, a bandwidth, burst duration, a time domain spacing, a transmit signal power, a signal format, a signal direction, a time resource, a frequency domain resource, and a quasi co-location QCL relationship.

In some implementations, the first indication information is further used to indicate at least one of the following:
identifier information of a target signal associated with a sensing measurement result;
sensing measurement identifier information;
a sensing measurement result; and
feedback information of the first indication information.

In some implementations, the feedback information of the first indication information includes at least one of the following:
a total quantity of bits of the first indication information;
a quantity of valid sensing measurement results corresponding to the first indication information;
a quantity of invalid sensing measurement results corresponding to the first indication information;
a quantity of sensing measurement results indicated in the first indication information;
a quantity of invalidity causes indicated in the first indication information;
a quantity of recommended parameter configurations of a target signal that are indicated in the first indication information;
a quantity of bits for indicating a sensing measurement result in the first indication information;
a quantity of bits for indicating an invalidity cause in the first indication information; and
a quantity of bits for indicating a recommended target signal parameter configuration in the first indication information.

In some implementations, in a case that a first piece of sensing measurement result validity indicated in the first indication information is valid, the first indication information indicates a first sensing measurement result, and the first piece of sensing measurement result validity is one of the m pieces of sensing measurement result validity;
and/or
in a case that a second sensing measurement result is valid, the first indication information indicates at least one of the following:
sensing measurement result validity of the second sensing measurement result;
identifier information of a target signal associated with the second sensing measurement result;
sensing measurement identifier information of the second sensing measurement result; and
the second sensing measurement result, where
the second sensing measurement result is one of the m sensing measurement results;
and/or
in a case that a third piece of sensing measurement result validity indicated by the first indication information is invalid, the first indication information indicates at least one of the following:
indication information of an invalidity cause of a third sensing measurement result; and
a parameter configuration of a target signal, where
the third piece of sensing measurement result validity is one of the m pieces of sensing measurement result validity;
and/or
in a case that a fourth sensing measurement result is invalid, the first indication information indicates at least one of the following:
sensing measurement result validity of the fourth sensing measurement result;
indication information of an invalidity cause of the fourth sensing measurement result; and
a parameter configuration of a target signal, where
the fourth sensing measurement result is one of the m sensing measurement results;
and/or
in a case that a fifth sensing measurement result is valid, the first indication information does not indicate related information of the fifth sensing measurement result, where
the fifth sensing measurement result is one of the m sensing measurement results.

In some implementations, before the receiving, by a second device, first indication information sent by a first device, the method further includes:
sending, by the second device, second indication information to the first device, where the second indication information is used to indicate at least one of the following:
whether sensing measurement result validity needs to be fed back;
a feedback configuration of sensing measurement result validity and communication data reception correctness;
a criterion for determining sensing measurement result validity;
a sensing measurement quantity;
a sensing requirement; and
a sensing service.

In some implementations, the feedback configuration of the sensing measurement result validity and the communication data reception correctness includes at least one of the following:
a feedback timing;
a feedback resource;
a feedback manner;
a joint feedback configuration or indication; and
a format of the first indication information;
and/or
the criterion for determining the sensing measurement result validity includes at least one of the following:
whether quality of the target signal detected by the first device reaches a threshold requirement;
whether a sensing measurement result obtained by the first device meets a sensing requirement;
whether the first device correctly demodulates data in a case that the target signal is a communication data signal; and
whether the first device obtains a sensing measurement result when a feedback time point of the first indication information arrives.

In some implementations, before the receiving, by a second device, first indication information sent by a first device, the method further includes:
sending, by the second device, third indication information to the first device, where the third indication information is used to indicate at least one of the following:
indication information of whether sensing measurement is allowed based on a communication data symbol;
configuration information of a communication data signal for sensing measurement; and
sensing quality of service QoS information.

It should be noted that this embodiment is used as an implementation of the second device corresponding to the embodiment shown in FIG. 4. For a specific implementation of this embodiment, refer to the related descriptions of the embodiment shown in FIG. 4. To avoid repetition, details are not described again in this embodiment.

The following uses a plurality of embodiments to illustrate the method provided in the embodiments of this application.

### Embodiment 1

This embodiment mainly describes a format of first indication information, which is specifically as follows:

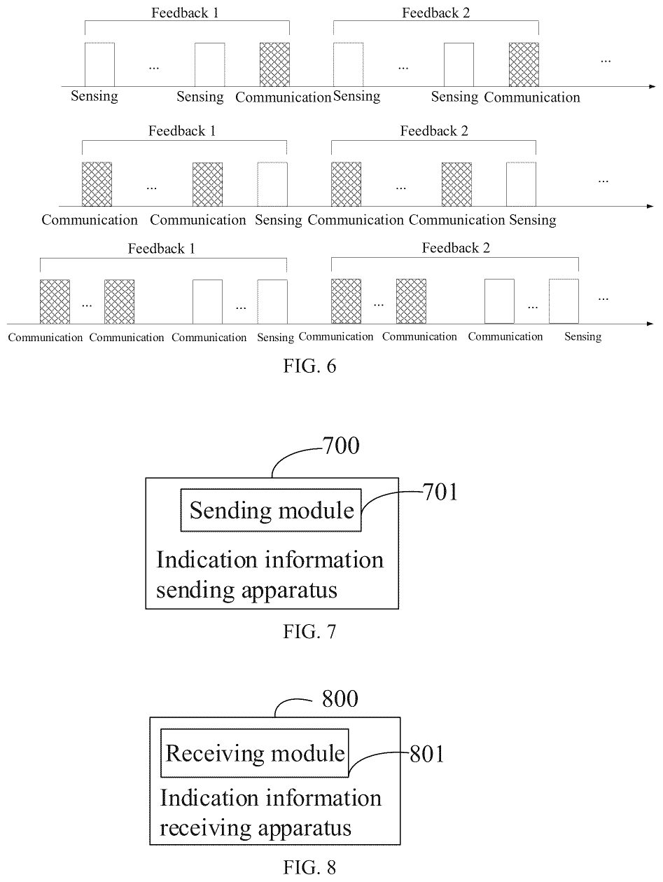

In this embodiment, m sensing measurement result validity indications and n communication data reception correctness indications are fed back each time. As shown in FIG. 6, there are three cases: m>1 and n=1; m=1 and n>1; and m>1 and n>1. Each sensing measurement result (or each sensing measurement result validity indication) is associated with one or more sensing measurements, and one sensing measurement may be measurement based on one or more target signals.

In this embodiment, the format of the first indication information may include the following:

Manner 1: That a measurement result is valid or a measurement result is invalid+communication data is correctly received or incorrectly received are fed back, which may be specifically as follows:

In manner 1, m+n bits may be fed back. For example:

In one case, m bits and n bits respectively indicate sensing measurement result validity and communication data reception correctness. Joint coding or independent coding may be adopted, where bit rates in the independent coding may be different, so that different priority or importance requirements can be met. The m bits indicate sensing measurement result validity. For example, for each 1 bit in the m bits, “0” indicates that a sensing measurement result is invalid, and “1” indicates that a sensing measurement result is valid; and the n bits indicate communication data reception correctness, that is, an ACK/a NACK. For example, for each of the n bits, “0” indicates that communication data is incorrectly received (NACK), and “1” indicates that communication data is correctly received (ACK).

In another case, there are x (x≤m and x≤n) associated sensing measurement result validity and communication data reception correctness indications (a total of 2×x bits) in the m sensing measurement result validity indications and the n communication data reception correctness indications. Each associated 2 bits jointly indicate sensing measurement result validity and communication data reception correctness through joint coding, that is, each 2 bits represent four states. In particular, for example, if a case that communication data is incorrectly received but a sensing measurement result is valid does not exist, a value of 2 bits corresponding to the state (communication data is incorrectly received and a sensing measurement result is valid) may be Reserved, as specifically shown in Table 2.

Remaining m−x bits and n−x bits respectively indicate sensing measurement result validity and communication data reception correctness, which may be specifically shown in Table 3.

TABLE 3

| | | | | | | | | | |
|---|---|---|---|---|---|---|---|---|---|
| Joint coding | Joint coding | . . . | Joint coding | Sensing | . . . | Sensing | ACK/NACK | . . . | ACK/NACK |
| (2 bits) of | (2 bits) of | | (2 bits) of | indication | | indication | x + 1 | | n |
| sensing | sensing | | sensing | x + 1 | | m | | | |
| indication 1 | indication 2 | | indication x | | | | | | |
| and | and | | and | | | | | | |
| ACK/NACK 1 | ACK/NACK 2 | | ACK/NACK x | | | | | | |

It should be noted that an order of joint coding indication information, sensing measurement result validity indication information, and communication data reception correctness indication information is not limited, for example, may be determined according to a feedback priority. For details of the priority, refer to the corresponding descriptions of the foregoing embodiment. The three may be independently coded.

In particular, when there are the following cases: x=m, x=n, and x=m=n, there may be no bit for independently indicating sensing measurement result validity and/or communication data reception correctness, which may be shown in Table 4 to Table 6.

TABLE 4
x = m < n

| | | | | | | |
|---|---|---|---|---|---|---|
| Joint coding (2 | Joint coding (2 | . . . | Joint coding (2 | ACK/NACK | . . . | ACK/ |
| bits) of sensing | bits) of sensing | | bits) of sensing | m + 1 | | NACK |
| indication 1 and | indication 2 and | | indication m and | | | n |
| ACK/NACK 1 | ACK/NACK 2 | | ACK/NACK m | | | |

TABLE 5
x = n < m

| | | | | | | |
|---|---|---|---|---|---|---|
| Joint coding (2 | Joint coding (2 | . . . | Joint coding (2 | Sensing | . . . | Sensing |
| bits) of sensing | bits) of sensing | | bits) of sensing | indication | | indication |
| indication 1 and | indication 2 and | | indication n and | x + 1 | | m |
| ACK/NACK 1 | ACK/NACK 2 | | ACK/NACK n | | | |

TABLE 6
x = m = n

| | | | |
|---|---|---|---|
| Joint coding (2 | Joint coding (2 | . . . | Joint coding (2 |
| bits) of sensing | bits) of sensing | | bits) of sensing |
| indication 1 and | indication 2 and | | indication m(n) and |
| ACK/NACK 1 | ACK/NACK 2 | | ACK/NACK m(n) |

In manner 1, 2 bits may be fed back. For example, 1 bit is used as a logic AND result of m bits used to indicate m pieces of sensing measurement result validity, where “0” indicates that at least one of m sensing measurement results is invalid, and “1” indicates that all the m sensing measurement results are valid. The other 1 bit is used as a logic AND result of n bits used to indicate n pieces of communication data reception correctness, where “0” indicates that at least one of the n communication data reception correctness indications is a reception incorrect indication (NACK), and “1” indicates that all the n communication data reception correctness indications are reception correct indications (ACK).

In addition, 1 bit indicating sensing measurement result validity may be: “1” is fed back when more than x (x≤m, and the effect is equivalent to logic AND when x=m) of the m sensing measurement results are valid; otherwise, “0” is fed back.

In manner 1, 1 bit may be fed back. For example, as a logic AND result of m bits used to indicate sensing measurement result validity and n bits used to indicate communication data reception correctness, “0” indicates that at least one of m sensing measurement results is invalid or at least one of n communication data reception correctness indications is a reception incorrect indication (NACK), and “1” indicates that all the m sensing measurement results are valid and all the n communication data reception correctness indications are reception correct indications (ACK).

In manner 1, m+n−x bits may be fed back. There are x (x≤m and x≤n) associated sensing measurement result validity and communication data reception correctness indications (a total of 2x bits) in the m sensing measurement result validity indications and the n communication data reception correctness indications. Logic AND is performed on each associated 2 bits to obtain x bits. Each of the x bits is used to indicate associated sensing measurement result validity and communication data reception correctness, where “0” indicates that communication data is incorrectly received (NACK) or a sensing measurement result is invalid, and “1” indicates that communication data is correctly received (ACK) and a sensing measurement result is valid.

Remaining m−x bits and n−x bits respectively indicate sensing measurement result validity and communication data reception correctness. In particular, when the following cases exist: x=m<n, x=n<m, and x=m=n, there may be no bit for independently indicating sensing measurement result validity and/or communication data reception correctness. For a specific format, reference may be made to the formats shown in the foregoing Table 3 to Table 6, and joint coding indication information is 1 bit.

In manner 1, if there are x (x≤m and x≤n) associated sensing measurement result validity and communication data reception correctness indications (a total of 2×x bits) in the m sensing measurement result validity indications and the n communication data reception correctness indications, the x sensing measurement result validity indications are sensing measurement result validity indications based on communication data, that is, the target signal is a communication data signal, and each associated 2 bits may be represented by 1 bit or 2 bits. A specific method is as follows:

When communication data is incorrectly received, 1 bit is used for indication, where “0” indicates that communication data is incorrectly received (NACK) and a sensing measurement result is invalid; or
when communication data is correctly received, 2 bits are used for indication, where 1 bit “1” indicates that communication data is correctly received (ACK), and the other 1 bit is used to indicate whether a sensing measurement result is valid.

In addition, a communication data reception correctness indication and a sensing measurement result validity indication may be independently coded, and the communication data reception correctness indication is located front. For example, a second device first decodes the communication data reception correctness indication information to obtain n pieces of communication data reception correctness indication information and how many reception correct indication (ACK) exist in x pieces of communication reception correctness indication information associated with sensing, so that a quantity of bits for the subsequent sensing measurement result validity indication can be determined.

In manner 1, m×u+n (m>1) bits may be fed back, which may be specifically corresponding to validity of m sensing measurement results. Validity of each sensing measurement result is represented by using u bits, and corresponds to v states related to validity. Therefore, u=ceil (log 2(v)) bits are required. For example, validity of sensing measurement results is classified into different levels, that is, target signal quality (an SNR, an RSRP, an RSSI, a signal clutter ratio, or the like) or sensing performance indicators corresponding to measurement results are different. In some implementations, there are a plurality of thresholds for determining validity of a measurement result. (It is assumed that there are two thresholds), there may be three states: being invalid, being valid for a first threshold but being invalid for a second threshold, and being valid for the second threshold (it is assumed that the second threshold has a higher requirement). Sensing measurement result validity and communication data reception correctness may be respectively indicated by using m×u bits and n bits.

In manner 1, 1+n bits may be fed back. 1 bit may be a logic AND result of m sensing measurement result validity indication bits, where “0” indicates that at least one sensing measurement result is invalid, and “1” indicates that all m sensing measurement results are valid; or “1” is fed back when more than x (x<m) of m sensing measurement results are valid; otherwise, “0” is fed back. The other n bits are n communication data reception correctness indication bits.

In manner 1, m+1 bits may be fed back, where m bits are m sensing measurement result validity indication bits, and the other 1 bit is logic AND of n communication data reception correctness indication bits.

Manner 2: That a measurement result is valid+a sensing measurement result+a communication data reception correctness indication are fed back or that a measurement result is invalid+a communication data reception correctness indication are fed back, which may be specifically as follows:

When a sensing measurement result is valid, “1” is fed back to indicate that a sensing result is valid, the sensing measurement result is fed back, and a communication data reception correctness indication is fed back. When a sensing measurement result is invalid, “0” is fed back to indicate that a sensing result is invalid, and a communication data reception correctness indication is fed back. In some implementations, the format may include the following:

In one case, a sensing measurement result may be fed back each time when a validity indication is fed back, and then a communication data reception correctness indication is fed back, for example, as shown in the following Table 7:

TABLE 7

| | | | | | | | | | | |
|---|---|---|---|---|---|---|---|---|---|---|
| 1 | Result 1 | 0 | 1 | Result 3 | . . . | 1 | Result m | ACK/NACK 1 | . . . | ACK/NACK n |

In one case, n bit validity indications may be first fed back, then a sensing measurement result is fed back, and then a communication data reception correctness indication is fed back. For example, as shown in the following Table 8:

TABLE 8

| | | | | | | | | | | | |
|---|---|---|---|---|---|---|---|---|---|---|---|
| 1 | 0 | 1 | . . . | 1 | Result 1 | Result 3 | . . . | Result m | AK/NACK 1 | . . . | ACK/NACK n |

In one case, a sensing measurement result validity indication and a communication data reception correctness indication may be first fed back, and then a sensing measurement result is fed back. For example, as shown in the following Table 9:

TABLE 9

| | | | | | | | | | | | |
|---|---|---|---|---|---|---|---|---|---|---|---|
| 1 | 0 | 1 | . . . | 1 | ACK/NACK 1 | . . . | ACK/NACK n | Result 1 | Result 3 | . . . | Result m |

It should be noted that the foregoing feedback format of the first indication information may also be that a communication data reception correctness indication is before a sensing measurement result validity indication and a sensing measurement result. For example, information with a higher priority is placed in the front. Communication is placed in the front when a communication feedback is more important, and conversely, sensing is placed in the front.

Further, in manner 2, a sensing measurement result validity indication bit and a communication data reception correctness indication bit may be combined for feedback according to the descriptions in manner 1; or a sensing measurement result validity indication is represented by using a plurality of bits.

It should be noted that, when a sensing measurement result is fed back, a quantity of bits of each sensing measurement result is fixed, and may be agreed upon by sending and receiving parties (specified in a protocol), or a quantity of bits of a sensing measurement result/a quantity of bits of the first indication information are/is indicated by a sending party of the first indication information. In particular, in some cases of manner 2, m-bit validity indications are before sensing results, and the validity indications and the sensing results may be separately coded. The second device first detects the preceding m-bit validity indications, and then knows a quantity of subsequent sensing results. In this case, a receive end can correctly perform decoding only a quantity of bits of each sensing measurement result is known. The same is true for the following feedback on a sensing measurement result invalidity cause and a recommended target signal parameter configuration.

Manner 3: That a measurement result is valid+a sensing measurement result+a communication data reception correctness indication are fed back or that a measurement result is invalid+an invalidity cause+a communication data reception correctness indication are fed back, which may be specifically as follows:

When a sensing measurement result is valid, “1” is fed back to indicate that a sensing result is valid, the sensing measurement result is fed back, and a communication data reception correctness indication is fed back. When a sensing measurement result is invalid, “0” is fed back to indicate that a sensing result is invalid, a sensing measurement result invalidity cause is fed back, and a communication data reception correctness indication is fed back. Specifically, the format may include the following:

In one case, a sensing measurement result or an invalidity cause may be fed back each time when a validity indication is fed back, and then a communication data reception correctness indication is fed back. For example, as shown in the following Table 10:

TABLE 10

| | | | | | | | | | | | |
|---|---|---|---|---|---|---|---|---|---|---|---|
| 1 | Result 1 | 0 | Cause 2 | 1 | Result 3 | . . . | 1 | Result m | ACK/NACK 1 | . . . | ACK/NACK n |

In one case, m-bit validity indications may be first fed back, then a sensing measurement result and an invalidity cause are sequentially fed back, and then a communication data reception correctness indication is fed back. For example, as shown in the following Table 11:

TABLE 11

| | | | | | | | | | | | | |
|---|---|---|---|---|---|---|---|---|---|---|---|---|
| 1 | 0 | 1 | . . . | 1 | Result 1 | Cause 2 | Result 3 | . . . | Result m | ACK/NACK 1 | . . . | ACK/NACK n |

In manner 3, a communication data reception correctness indication may be placed before or after a sensing measurement result validity indication or the two are alternately fed back, and then a sensing measurement result and an invalidity cause are sequentially fed back.

In manner 3, a sensing measurement result when the sensing measurement result is valid and an invalidity cause when the sensing measurement result is invalid may be separately fed back, and then a communication data reception correctness indication is fed back. Assuming that there are x valid sensing measurement results and y invalid sensing measurement results, the x sensing measurement results and p (p≤y) invalidity causes are fed back. For example, as shown in the following Table 12:

TABLE 12

| | | | | | | | | | | | | | | |
|---|---|---|---|---|---|---|---|---|---|---|---|---|---|---|
| 1 | 0 | 1 | . . . | 1 | Result 1 | Result 2 | . . . | Result x | Invalidity | . . . | Invalidity | ACK/NACK 1 | . . . | ACK/NACK n |
| | | | | | | | | | cause 1 | | cause p | | | |

It should be noted that, information with high importance or a high delay requirement may also be placed in front. For example, if a sensing measurement result is more important, the sensing measurement result is placed in front, or a sensing measurement result may be independently coded.

In some implementations, an invalidity cause may be before a sensing measurement result. In some implementations, a communication data reception correctness indication may be placed before or after a sensing measurement result validity indication or the two are alternately fed back, and then a sensing measurement result and an invalidity cause are separately fed back. For example, communication is placed in the front when a communication feedback is more important, and conversely, sensing is placed in the front. In addition, the same is true for the following order of a measurement result, an invalidity cause, and a recommended target signal parameter configuration.

Further, a sensing measurement result validity indication bit and a communication data reception correctness indication bit may be combined for feedback as described in manner 1; or a sensing measurement result validity indication is represented a plurality of multiple bits.

It should be noted that a quantity of invalidity causes that are fed back may be less than a quantity of invalid sensing measurement results, because a same invalidity cause may be fed back only once or only invalidity causes of a part of invalid sensing measurement results are selected to be fed back. Compared with a manner of sequentially feeding back a sensing measurement result and an invalidity cause, feedback overheads can be reduced. However, because a quantity of bits of the first indication information is uncertain, a total quantity of bits for feedback or a quantity of invalidity causes that are fed back need to be indicated. Otherwise, a receive end may not correctly decode the first indication information. In addition, the same is true for the following feedback on a sensing measurement result invalidity cause.

Manner 4: That a measurement result is valid+a sensing measurement result+a communication data reception correctness indication are fed back or that a measurement result is invalid+a recommended target signal parameter configuration+a communication data reception correctness indication are fed back, which may be specifically as follows:

When a sensing measurement result is valid, “1” is fed back to indicate that a sensing result is valid, the sensing measurement result is fed back, and a communication data reception correctness indication is fed back. When a sensing measurement result is invalid, “0” is fed back to indicate that a sensing result is invalid, a recommended target signal parameter configuration is fed back, and a communication data reception correctness indication is fed back.

The specific format may be described in the foregoing manner 3, where an invalidity cause is replaced with a recommended target signal parameter configuration.

It should be noted that a quantity of recommended parameter configurations that are fed back may be less than a quantity of invalid sensing measurement results, because a same recommended parameter configuration may be fed back only once or only a part of recommended parameter configurations are selected to be fed back. For example, if a recommended parameter configuration 1 is a bandwidth of 100 MHz, and a recommended parameter configuration 2 is a bandwidth of 120 MHZ, only the recommended parameter configuration 2 is selected to be fed back. Compared with a manner of sequentially feeding back a sensing measurement result and a recommended parameter configuration, feedback overheads can be reduced. However, because a quantity of bits of the first indication information is uncertain, a total quantity of bits for feedback or a quantity of recommended target signal parameter configurations that are fed back may be indicated, to avoid a possibility that the second device may not correctly decode the first indication information. In addition, the same is true for the following feedback on a recommended target signal parameter configuration.

Manner 5: That a measurement result is valid+a sensing measurement result+a communication data reception correctness indication are fed back or that a measurement result is invalid+an invalidity cause+a recommended target signal parameter configuration+a communication data reception correctness indication are fed back, which may be specifically as follows:

When a sensing measurement result is valid, “1” is fed back to indicate that a sensing result is valid, the sensing measurement result is fed back, and a communication data reception correctness indication is fed back. When a sensing measurement result is invalid, “0” is fed back to indicate that a sensing result is invalid, a sensing measurement result invalidity cause and a recommended target signal parameter configuration are fed back, and a communication data reception correctness indication is fed back.

The specific format is described in the foregoing manner 3, where an invalidity cause is replaced with an invalidity cause+a recommended target signal parameter configuration.

In addition, an order of a communication data reception correctness indication, a sensing measurement result validity indication, and a sensing measurement result validity indication or an invalidity cause may be determined according to feedback priorities, and an invalidity cause and a recommended target signal parameter configuration may also be determined according to importance. In this case, the two may be independently coded.

Manner 6: That a measurement result is valid+a communication data reception correctness indication are fed back or that a measurement result is invalid+an invalidity cause+communication data reception correctness indication are fed back, which may be specifically as follows:

When a sensing measurement result is valid, “1” is fed back to indicate that a sensing result is valid, and a communication data reception correctness indication is fed back. When a sensing measurement result is invalid, “0” is fed back to indicate that a sensing result is invalid, a sensing measurement result invalidity cause is fed back, and a communication data reception correctness indication is fed back.

The specific format is described in the foregoing manner 3, where a sensing measurement result is no longer fed back when a sensing measurement result is valid.

Manner 7: That a measurement result is valid+a communication data reception correctness indication are fed back or that a measurement result is invalid+a recommended target signal parameter configuration+a communication data reception correctness indication are fed back, which may be specifically as follows:

When a sensing measurement result is valid, “1” is fed back to indicate that a sensing result is valid, and a communication data reception correctness indication is fed back. When a sensing measurement result is invalid, “0” is fed back to indicate that a sensing result is invalid, a recommended target signal parameter configuration is fed back, and a communication data reception correctness indication is fed back.

The specific format is described in the foregoing manner 3, where a sensing measurement result is no longer fed back when a sensing measurement result is valid, and an invalidity cause is replaced with a recommended target signal parameter configuration.

Manner 8: That a measurement result is valid+a communication data reception correctness indication are fed back or that a measurement result is invalid+an invalidity cause+a recommended target signal parameter configuration+a communication data reception correctness indication are fed back, which may be specifically as follows:

When a sensing measurement result is valid, “1” is fed back to indicate that a sensing result is valid, and a communication data reception correctness indication is fed back. When a sensing measurement result is invalid, “0” is fed back to indicate that a sensing result is invalid, a recommended target signal parameter configuration is fed back, and a communication data reception correctness indication is fed back.

The specific format is described in the foregoing manner 5, where a sensing measurement result is no longer fed back when a sensing measurement result is valid.

In addition, only when a first sensing measurement result is valid, the first indication information sent by the first device to the second device includes a sensing measurement result validity indication of the first sensing measurement result and/or a sensing measurement result and/or target signal identifier information and/or sensing measurement identifier information that are/is associated with a sensing measurement result. When a measurement result is invalid, the first indication information does not include related feedback information of the first sensing measurement result, and the first sensing measurement result is one of the m sensing measurement results.

Only when a first sensing measurement result is invalid, the first indication information sent by the first device to the second device includes a sensing measurement result validity indication of the first sensing measurement result and/or a sensing measurement result invalidity cause and/or a recommended target signal parameter configuration; or when a measurement result is valid, the first indication information does not include related feedback information of the first sensing measurement result, and the first sensing measurement result is one of the m sensing measurement results.

In addition, in this embodiment of this application, a sensing measurement result, a sensing requirement, and a sensing service may be defined as follows:

The sensing measurement result is a measurement result associated with a sensing measurement quantity, that is, a value of a measurement quantity. Specifically, at least one of the following may be included:
original channel information: a channel matrix H or compressed quantization information of H, and Channel State Information (CSI), for example, an amplitude of a frequency domain channel response, or a square and/or a phase of the amplitude of the frequency domain channel response, or I-channel and Q-channel signal characteristics of the frequency domain channel response, for example, an amplitude/a square of an amplitude of an I-channel and/or a Q-channel signal;
signal strength information: an RSRP and an RSSI;
spectrum information: a channel Power-Delay Profile (PDP), a Doppler power spectrum, a Power Azimuth Spectrum (PAS), pseudo-spectrum information (for example, an MUSIC spectrum), a delay-Doppler two-dimensional spectrum, and a delay-Doppler-azimuth three-dimensional spectrum;
multipath information: Power, phase, delay, and angle information of each path (including at least a first-arrival path, an LOS path, a first-order reflection path, or a multi-order reflection path) in a multipath channel;
angle information: an angle of arrival and an angle of departure (including angle information on a terminal side, angle information on a base station side, and angle information of a reflection point);
difference information of signals corresponding to different antennas: a quotient or a conjugate product of frequency domain channel responses of a first antenna and a second antenna (or an amplitude or a phase of the quotient or the conjugate product of the frequency domain channel responses of the first antenna and the second antenna, or an I channel or a Q channel of the quotient or the conjugate product of the frequency domain channel responses of the first antenna and the second antenna, or a projection operation on the I channel or the Q channel of the quotient or the conjugate product of the frequency domain channel responses of the first antenna and the second antenna, where the projection operation may be I*cos (theta)+Q*sin (theta), where theta is an angle value, different theta corresponds to different projections, I represents I-channel data, and Q represents Q-channel data), an amplitude ratio or an amplitude difference of receiving signals of the first antenna and the second antenna, a phase difference between signals of the first antenna and the second antenna, and a delay difference between signals of the first antenna and the second antenna; and
target parameter information determined based on the original channel information: a Doppler spread, a Doppler frequency shift, a maximum delay spread, an angle spread, a coherence bandwidth, and a coherent time.

In addition to the foregoing measurement quantities, a new measurement quantity generated by performing an operation based on two or more of the foregoing measurement quantities is included.

The sensing requirement information may include at least one of the following:
a sensing service type, for example, intrusion detection, track tracing, environment reconstruction, respiration detection, and action identification;
a sensing area, for example, geographic coordinates of the sensing area, and a length, a width, a height, a distance, an angle range, and the like of the sensing area;
a sensing target type, for example, a car, a motorcycle, and a pedestrian, indicating a moving speed range of a sensing target and a reflected power level of a radio signal;
sensing/integrated sensing and communication QoS, for example, a priority of a sensing/integrated sensing and communication service, a requirement for a sensing resolution, a requirement for sensing precision or a sensing error, a sensing delay budget, a requirement for a maximum sensing range, a requirement for a continuous sensing capability, a requirement for a sensing update frequency, a detection probability, a false alarm probability, a requirement for a missed detection probability, and the like;
communication QoS (for an integrated sensing and communication service), for example, a communication delay budget, and a false alarm rate;
a quantity of sensing targets in a sensing area; and
a sensing target density in a sensing area.

The sensing service may be at least one of the following:
object characteristic detection: information that can reflect an attribute or a state of a target object, which may be at least one of the following: existence of the target object, a location of the target object, a speed of the target object, an acceleration of the target object, a material of the target object, a shape of the target object, a type of the target object, a Radar Cross Section (RCS) of the target object, a polarization scattering characteristic, and the like;
event detection: information related to a target event, that is, information that can be detected/sensed when the target event occurs, which may be: fall detection, intrusion detection, quantity statistics, indoor positioning, gesture recognition, lip language recognition, gait recognition, expression recognition, respiration monitoring, heart rate monitoring, sound source discrimination, and the like; and
environment detection: humidity, brightness, temperature, atmospheric pressure, air quality, a weather condition, a terrain, construction/vegetation distribution, population statistics, a population density, a vehicle density, and the like.

In this embodiment of this application, the criterion for determining whether a sensing measurement result is valid may include at least one of the following:
whether first signal quality (including at least one of an SNR, an RSRP, an RSSI, and a signal clutter ratio) detected by the receive end meets a threshold requirement;
whether a sensing measurement result obtained by the receive end meets a sensing requirement, that is, whether a sensing performance indicator corresponding to the calculated sensing measurement result meets the requirement, where the sensing performance indicator may be at least one of the following:
sensing precision/a sensing error, a sensing resolution, a sensing range, a sensing delay, a detection probability, a false alarm probability, a quantity of targets detected at the same time, a signal clutter ratio, a signal sidelobe characteristic (a ratio of a main lobe to a sidelobe of a signal), a peak-to-average power ratio PAPR, a variance, a standard deviation, and a ratio of a target sensing signal component to another sensing signal component, where for example, an amplitude corresponding to a sample point with a largest Doppler amplitude in respiration detection is a target sensing component, that is, the sample point with the largest amplitude is a sample point corresponding to a respiration frequency, and an amplitude corresponding to a sample point other than the sample point with the largest amplitude is used as another sensing signal component;
whether the receive end correctly demodulates data, that is, sensing is performed based on communication data, and demodulation is performed first and then a sensing parameter is estimated, and if communication demodulation is incorrect, a sensing measurement result is affected and becomes unreliable; and
whether the receive end successfully obtains a sensing measurement result when a feedback time point arrives, for example, whether sensing measurement result processing expires.

When the sensing measurement result meets at least one of the foregoing, it is considered that a sensing measurement result is valid; otherwise, it is considered that a sensing measurement result is invalid. For example, when the first connection and the second condition are met, that is, the first signal quality meets the threshold requirement and the sensing measurement result meets the sensing requirement, it is considered that the sensing measurement result is valid.

In this embodiment of this application, a first device performs sensing measurement according to indication information related to a sensing measurement signal configuration, feeds back m pieces of sensing measurement result validity and n pieces of communication data reception correctness, and feeds back information such as a sensing measurement result, a sensing measurement result invalidity cause, and a recommended sensing measurement signal configuration according to the sensing measurement result validity. A feedback format is determined according to the sensing measurement result validity and the communication data reception correctness, so that overheads can be effectively reduced. A party that receives a sensing measurement result is assisted to further process the sensing measurement result, or adjust a configuration of a sensing measurement signal, so as to obtain better sensing measurement performance.

Referring to FIG. 7, FIG. 7 is a structural diagram of an indication information sending apparatus according to an embodiment of this application. As shown in FIG. 7, the apparatus includes:
a sending module 701, configured to send first indication information to a second device, where the first indication information is used to indicate m pieces of sensing measurement result validity and n pieces of communication data reception correctness, m and n are positive integers, and m+n>2, where
m sensing measurement results corresponding to the m pieces of sensing measurement result validity are measurement results of performing sensing measurement on a target signal received by the first device.

In some implementations, the first indication information includes an indication bit, and the indication bit is at least one bit indicating the m pieces of sensing measurement result validity and the n pieces of communication data reception correctness.

In some implementations, the indication bit is m+n bits, where
m bits indicate the m pieces of sensing measurement result validity, and n bits indicate the n pieces of communication data reception correctness; or
2x bits in the m+n bits indicate x pieces of sensing measurement result validity and x pieces of communication data reception correctness through joint coding; and in a case that x is less than m, m−x bits in the m+n bits indicate m−x pieces of sensing measurement result validity, and in a case that x is less than n, n−x bits in the m+n bits indicate n−x pieces of sensing measurement result validity, where x is a positive integer, x is less than or equal to m, and x is less than or equal to n.

In some implementations, the indication bit is 2 bits, a first value of a first bit in the 2 bits indicates that at least one of the m pieces of sensing measurement result validity is invalid, and a second value of the first bit indicates that all the m pieces of sensing measurement result validity are valid; and a first value of a second bit in the 2 bits indicates that at least one of the n pieces of communication data reception correctness is incorrect, and a second value of the second bit in the 2 bits indicates that all the n pieces of communication data reception correctness are correct;
or
the indication bit is 1 bit, a second value of the first bit indicates that all the m pieces of sensing measurement result validity are valid, all the n pieces of communication data reception correctness are correct, and a first value of the 1 bit indicates at least one of the following:
at least one of the m pieces of sensing measurement result validity is invalid, and at least one of the n pieces of communication data reception correctness is incorrect.

In some implementations, the indication bit is m+n−x bits, where x bits in the m+n−x bits respectively indicate x joint indications, and each joint indication is a joint indication of one piece of sensing measurement result validity and one piece of communication data reception correctness; and in a case that x is less than m, m−x bits in the m+n−x bits indicate m−x pieces of sensing measurement result validity, and in a case that x is less than n, n−x bits in the m+n−x bits indicate n−x pieces of sensing measurement result validity, where x is a positive integer, x is less than or equal to m, and x is less than or equal to n.

In some implementations, the indication bit includes x bit groups, the x bit groups respectively indicate x joint indications, and each joint indication is a joint indication of one piece of sensing measurement result validity and one piece of communication data reception correctness, where
the x bit groups include at least one of the following:
a bit group of 1 bit, where the bit group of 1 bit indicates that communication data reception correctness in a corresponding joint indication is incorrect and sensing measurement result validity is invalid; and
a bit group of 2 bits, where a 1-bit indication in the bit group of 2 bits indicates that communication data reception correctness in a corresponding joint indication is correct, and the other 1 bit indicates sensing measurement result validity in the corresponding joint indication; and
in a case that x is less than m, the indication bit further includes m−x bits indicating m−x pieces of sensing measurement result validity; and
in a case that x is less than n, the indication bit further includes n−x bits indicating n−x pieces of sensing measurement result validity, where
x is a positive integer, x is less than or equal to m, and x is less than or equal to n.

In some implementations, the indication bit is m×u+n bits, where m×u bits respectively indicate levels of the m pieces of sensing measurement result validity, and n bits indicate the n pieces of communication data reception correctness.

In some implementations, the first indication information is further used to indicate at least one of the following:
a sensing measurement result invalidity cause; and
a parameter configuration of a target signal.

In some implementations, the sensing measurement result invalidity cause is at least one of the following:
quality of the target signal detected by the first device does not reach a threshold requirement;
a sensing measurement result obtained by the first device does not meet a sensing requirement;
the first device does not correctly demodulate data in a case that the target signal is a communication data signal; and
the first device does not obtain a sensing measurement result when a feedback time point of the first indication information arrives.

In some implementations, the parameter configuration includes at least one of the following:
a waveform, a subcarrier spacing, a guard interval, a bandwidth, burst duration, a time domain spacing, a transmit signal power, a signal format, a signal direction, a time resource, a frequency domain resource, and a quasi co-location QCL relationship.

In some implementations, the first indication information is further used to indicate at least one of the following:
identifier information of a target signal associated with a sensing measurement result;
sensing measurement identifier information;
a sensing measurement result; and
feedback information of the first indication information.

In some implementations, the feedback information of the first indication information includes at least one of the following:
a total quantity of bits of the first indication information;
a quantity of valid sensing measurement results corresponding to the first indication information;
a quantity of invalid sensing measurement results corresponding to the first indication information;
a quantity of sensing measurement results indicated in the first indication information;
a quantity of invalidity causes indicated in the first indication information;
a quantity of recommended parameter configurations of a target signal that are indicated in the first indication information;
a quantity of bits for indicating a sensing measurement result in the first indication information;
a quantity of bits for indicating an invalidity cause in the first indication information; and
a quantity of bits for indicating a recommended target signal parameter configuration in the first indication information.

In some implementations, in a case that a first piece of sensing measurement result validity indicated in the first indication information is valid, the first indication information indicates a first sensing measurement result, and the first piece of sensing measurement result validity is one of the m pieces of sensing measurement result validity;
and/or
in a case that a second sensing measurement result is valid, the first indication information indicates at least one of the following:
sensing measurement result validity of the second sensing measurement result;
identifier information of a target signal associated with the second sensing measurement result;
sensing measurement identifier information of the second sensing measurement result; and
the second sensing measurement result, where
the second sensing measurement result is one of the m sensing measurement results;
and/or
in a case that a third piece of sensing measurement result validity indicated by the first indication information is invalid, the first indication information indicates at least one of the following:
indication information of an invalidity cause of a third sensing measurement result; and
a parameter configuration of a target signal, where
the third piece of sensing measurement result validity is one of the m pieces of sensing measurement result validity;
and/or
in a case that a fourth sensing measurement result is invalid, the first indication information indicates at least one of the following:
sensing measurement result validity of the fourth sensing measurement result;
indication information of an invalidity cause of the fourth sensing measurement result; and
a parameter configuration of a target signal, where
the fourth sensing measurement result is one of the m sensing measurement results;
and/or
in a case that a fifth sensing measurement result is valid, the first indication information does not indicate related information of the fifth sensing measurement result, where
the fifth sensing measurement result is one of the m sensing measurement results;
and/or
in a case that a sixth sensing measurement result is valid, the first indication information does not indicate related information of the sixth sensing measurement result, where
the sixth sensing measurement result is one of the m sensing measurement results.

In some implementations, the apparatus further includes:
a first receiving module, configured to receive second indication information sent by the second device, where the second indication information is used to indicate at least one of the following:
whether sensing measurement result validity needs to be fed back;
a feedback configuration of sensing measurement result validity and communication data reception correctness;
a criterion for determining sensing measurement result validity;
a sensing measurement quantity;
a sensing requirement; and
a sensing service.

In some implementations, the feedback configuration of the sensing measurement result validity and the communication data reception correctness includes at least one of the following:
a feedback timing;
a feedback resource;
a feedback manner;
a joint feedback configuration or indication; and
a format of the first indication information;
and/or
the criterion for determining the sensing measurement result validity includes at least one of the following:
whether quality of the target signal detected by the first device reaches a threshold requirement;
whether a sensing measurement result obtained by the first device meets a sensing requirement;
whether the first device correctly demodulates data in a case that the target signal is a communication data signal; and
whether the first device obtains a sensing measurement result when a feedback time point of the first indication information arrives.

In some implementations, the apparatus further includes:
a second receiving module, configured to receive third indication information sent by the second device, where the third indication information is used to indicate at least one of the following:
indication information of whether sensing measurement is allowed based on a communication data symbol;
configuration information of a communication data signal for sensing measurement; and
sensing quality of service QoS information.

The foregoing indication information sending apparatus can implement sensing measurement.

The indication information sending apparatus in this embodiment of this application may be an electronic device, for example, an electronic device with an operating system, or may be a component in the electronic device, for example, an integrated circuit or a chip. For example, the electronic device may be a terminal, or may be another device other than the terminal. For example, the terminal may include but is not limited to the type of the terminal listed in this embodiment of this application. The another device may be a server, a network attached storage (Network Attached Storage, NAS), or the like. This is not specifically limited in this embodiment of this application.

The indication information sending apparatus provided in this embodiment of this application can implement the processes implemented in the method embodiment shown in FIG. 4, and achieve a same technical effect. To avoid repetition, details are not described herein again.

Referring to FIG. 8, FIG. 8 is a structural diagram of an indication information receiving apparatus according to an embodiment of this application. As shown in FIG. 8, the apparatus includes:
a receiving module 801, configured to receive first indication information sent by a first device, where the first indication information is used to indicate m pieces of sensing measurement result validity and n pieces of communication data reception correctness, and m+n>2, where
m sensing measurement results corresponding to the m pieces of sensing measurement result validity are measurement results of performing sensing measurement on a target signal received by the first device.

In some implementations, the first indication information includes an indication bit, and the indication bit is at least one bit indicating the m pieces of sensing measurement result validity and the n pieces of communication data reception correctness.

In some implementations, the indication bit is m+n bits, where
m bits indicate the m pieces of sensing measurement result validity, and n bits indicate the n pieces of communication data reception correctness; or
2x bits in the m+n bits indicate x pieces of sensing measurement result validity and x pieces of communication data reception correctness through joint coding; and in a case that x is less than m, m−x bits in the m+n bits indicate m−x pieces of sensing measurement result validity, and in a case that x is less than n, n−x bits in the m+n bits indicate n−x pieces of sensing measurement result validity, where x is a positive integer, x is less than or equal to m, and x is less than or equal to n.

In some implementations, the indication bit is 2 bits, a first value of a first bit in the 2 bits indicates that at least one of the m pieces of sensing measurement result validity is invalid, and a second value of the first bit indicates that all the m pieces of sensing measurement result validity are valid; and a first value of a second bit in the 2 bits indicates that at least one of the n pieces of communication data reception correctness is incorrect, and a second value of the second bit in the 2 bits indicates that all the n pieces of communication data reception correctness are correct;
or
the indication bit is 1 bit, a second value of the first bit indicates that all the m pieces of sensing measurement result validity are valid, all the n pieces of communication data reception correctness are correct, and a first value of the 1 bit indicates at least one of the following:
at least one of the m pieces of sensing measurement result validity is invalid, and at least one of the n pieces of communication data reception correctness is incorrect.

In some implementations, the indication bit is m+n−x bits, where x bits in the m+n−x bits respectively indicate x joint indications, and each joint indication is a joint indication of one piece of sensing measurement result validity and one piece of communication data reception correctness; and in a case that x is less than m, m−x bits in the m+n−x bits indicate m−x pieces of sensing measurement result validity, and in a case that x is less than n, n−x bits in the m+n−x bits indicate n−x pieces of sensing measurement result validity, where x is a positive integer, x is less than or equal to m, and x is less than or equal to n.

In some implementations, the indication bit includes x bit groups, the x bit groups respectively indicate x joint indications, and each joint indication is a joint indication of one piece of sensing measurement result validity and one piece of communication data reception correctness, where
the x bit groups include at least one of the following:
a bit group of 1 bit, where the bit group of 1 bit indicates that communication data reception correctness in a corresponding joint indication is incorrect and sensing measurement result validity is invalid; and
a bit group of 2 bits, where a 1-bit indication in the bit group of 2 bits indicates that communication data reception correctness in a corresponding joint indication is correct, and the other 1 bit indicates sensing measurement result validity in the corresponding joint indication; and
in a case that x is less than m, the indication bit further includes m−x bits indicating m−x pieces of sensing measurement result validity; and
in a case that x is less than n, the indication bit further includes n−x bits indicating n−x pieces of sensing measurement result validity, where
x is a positive integer, x is less than or equal to m, and x is less than or equal to n.

In some implementations, the indication bit is m×u+n bits, where m×u bits respectively indicate levels of the m pieces of sensing measurement result validity, and n bits indicate the n pieces of communication data reception correctness.

In some implementations, the first indication information is further used to indicate at least one of the following:
a sensing measurement result invalidity cause; and
a parameter configuration of a target signal.

In some implementations, the sensing measurement result invalidity cause is at least one of the following:
quality of the target signal detected by the first device does not reach a threshold requirement;
a sensing measurement result obtained by the first device does not meet a sensing requirement;
the first device does not correctly demodulate data in a case that the target signal is a communication data signal; and
the first device does not obtain a sensing measurement result when a feedback time point of the first indication information arrives.

In some implementations, the parameter configuration includes at least one of the following:
a waveform, a subcarrier spacing, a guard interval, a bandwidth, burst duration, a time domain spacing, a transmit signal power, a signal format, a signal direction, a time resource, a frequency domain resource, and a quasi co-location QCL relationship.

In some implementations, the first indication information is further used to indicate at least one of the following:
identifier information of a target signal associated with a sensing measurement result;
sensing measurement identifier information;
a sensing measurement result; and
feedback information of the first indication information.

In some implementations, the feedback information of the first indication information includes at least one of the following:
a total quantity of bits of the first indication information;
a quantity of valid sensing measurement results corresponding to the first indication information;
a quantity of invalid sensing measurement results corresponding to the first indication information;
a quantity of sensing measurement results indicated in the first indication information;
a quantity of invalidity causes indicated in the first indication information;
a quantity of recommended parameter configurations of a target signal that are indicated in the first indication information;
a quantity of bits for indicating a sensing measurement result in the first indication information;
a quantity of bits for indicating an invalidity cause in the first indication information; and
a quantity of bits for indicating a recommended target signal parameter configuration in the first indication information.

In some implementations, in a case that a first piece of sensing measurement result validity indicated in the first indication information is valid, the first indication information indicates a first sensing measurement result, and the first piece of sensing measurement result validity is one of the m pieces of sensing measurement result validity;
and/or
in a case that a second sensing measurement result is valid, the first indication information indicates at least one of the following:
sensing measurement result validity of the second sensing measurement result;
identifier information of a target signal associated with the second sensing measurement result;
sensing measurement identifier information of the second sensing measurement result; and
the second sensing measurement result, where
the second sensing measurement result is one of the m sensing measurement results;
and/or
in a case that a third piece of sensing measurement result validity indicated by the first indication information is invalid, the first indication information indicates at least one of the following:
indication information of an invalidity cause of a third sensing measurement result; and
a parameter configuration of a target signal, where
the third piece of sensing measurement result validity is one of the m pieces of sensing measurement result validity;
and/or
in a case that a fourth sensing measurement result is invalid, the first indication information indicates at least one of the following:
sensing measurement result validity of the fourth sensing measurement result;
indication information of an invalidity cause of the fourth sensing measurement result; and
a parameter configuration of a target signal, where
the fourth sensing measurement result is one of the m sensing measurement results;
and/or
in a case that a fifth sensing measurement result is valid, the first indication information does not indicate related information of the fifth sensing measurement result, where
the fifth sensing measurement result is one of the m sensing measurement results.

In some implementations, the apparatus further includes:
a first sending module, configured to send second indication information to the first device, where the second indication information is used to indicate at least one of the following:
whether sensing measurement result validity needs to be fed back;
a feedback configuration of sensing measurement result validity and communication data reception correctness;
a criterion for determining sensing measurement result validity;
a sensing measurement quantity;
a sensing requirement; and
a sensing service.

In some implementations, the feedback configuration of the sensing measurement result validity and the communication data reception correctness includes at least one of the following:
a feedback timing;
a feedback resource;
a feedback manner;
a joint feedback configuration or indication; and
a format of the first indication information;
and/or
the criterion for determining the sensing measurement result validity includes at least one of the following:
whether quality of the target signal detected by the first device reaches a threshold requirement;
whether a sensing measurement result obtained by the first device meets a sensing requirement;
whether the first device correctly demodulates data in a case that the target signal is a communication data signal; and
whether the first device obtains a sensing measurement result when a feedback time point of the first indication information arrives.

In some implementations, the apparatus further includes:
a second sending module, configured to send third indication information to the first device, where the third indication information is used to indicate at least one of the following:
indication information of whether sensing measurement is allowed based on a communication data symbol;
configuration information of a communication data signal for sensing measurement; and
sensing quality of service QoS information.

The foregoing indication information receiving apparatus can implement sensing measurement.

The indication information receiving apparatus in this embodiment of this application may be an electronic device, for example, an electronic device with an operating system, or may be a component in the electronic device, for example, an integrated circuit or a chip. For example, the electronic device may be a network side device, or may be another device other than the network side device. For example, the network side device may include but is not limited to the type of the network side device listed in this embodiment of this application. The another device may be a server, a network attached storage (Network Attached Storage, NAS), or the like. This is not specifically limited in this embodiment of this application.

The indication information receiving apparatus provided in this embodiment of this application can implement the processes implemented in the method embodiment shown in FIG. 5, and achieve a same technical effect. To avoid repetition, details are not described herein again.

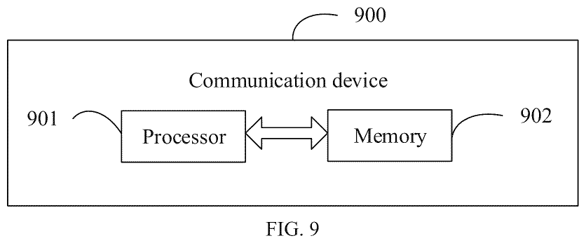

In some implementations, as shown in FIG. 9, an embodiment of this application further provides a communication device 900, including a processor 901 and a memory 902. The memory 902 stores a program or an instruction that can be run on the processor 901. For example, when the communication device 900 is a first device, the program or the instruction is executed by the processor 901 to implement the steps of the foregoing indication information sending method embodiment. When the communication device 900 is a second device, the program or the instruction is executed by the processor 901 to implement the steps of the foregoing indication information receiving method embodiment. To avoid repetition, details are not described herein again.

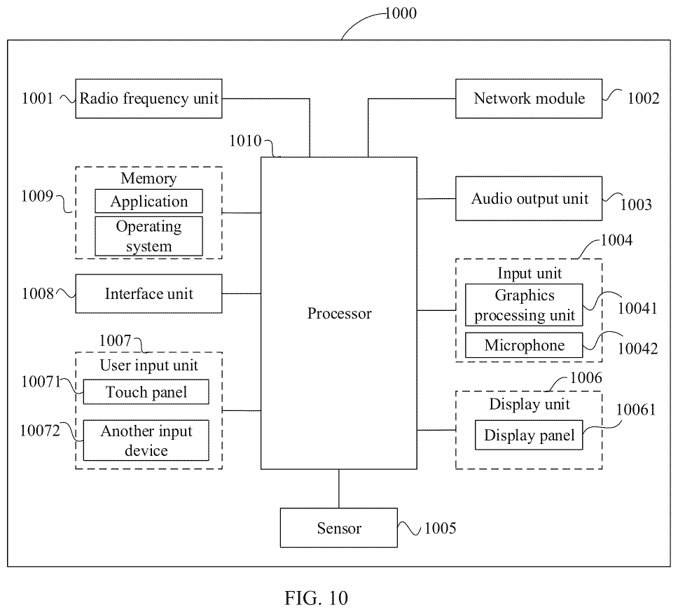

An embodiment of this application further provides a communication device. The communication device is a first device and includes a processor and a communication interface. The communication interface is configured to send first indication information to a second device, where the first indication information is used to indicate m pieces of sensing measurement result validity and n pieces of communication data reception correctness, m and n are positive integers, and m+n>2, where m sensing measurement results corresponding to the m pieces of sensing measurement result validity are measurement results of performing sensing measurement on a target signal received by the first device. The embodiment of the first device corresponds to the foregoing method embodiment on the side of the first device. Each implementation process and implementation of the foregoing method embodiment may be applicable to the embodiment of the first device. Specifically, FIG. 10 is a schematic structural diagram of hardware of a communication device according to an embodiment of this application.

The communication device 1000 is a first device and includes but is not limited to at least a part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the communication device 1000 may further include the power supply (for example, a battery) that supplies power to each component. The power supply may be logically connected to the processor 1010 by using a power supply management system, so as to manage functions such as charging, discharging, and power consumption by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that, in this embodiment of this application, the input unit 1004 may include a Graphics Processing Unit (GPU) 10041 and a microphone 10042, and the graphics processing unit 10041 processes image data of a still image or a video that is obtained by an image capturing apparatus (for example, a camera) in a video capturing mode or an image capturing mode. The display unit 1006 may include a display panel 10061. The display panel 10061 may be configured in a form such as a liquid crystal display or an organic light-emitting diode. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Usually, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may be a volatile memory or a non-volatile memory, or the memory 1009 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1009 in this embodiment of this application includes but is not limited to these memories and a memory of any other proper type.

The processor 1010 may include one or more processing units. In some implementations, an application processor and a modem processor are integrated into the processor 1010. The application processor mainly processes an operating system, a user interface, an application, and the like. The modem processor mainly processes a wireless communication signal, for example, a baseband processor. It can be understood that, in some implementations, the modem processor may not be integrated into the processor 1010.

The radio frequency unit 1001 is configured to send first indication information to a second device, where the first indication information is used to indicate m pieces of sensing measurement result validity and n pieces of communication data reception correctness, m and n are positive integers, and m+n>2, where
m sensing measurement results corresponding to the m pieces of sensing measurement result validity are measurement results of performing sensing measurement on a target signal received by the first device.

In some implementations, the first indication information includes an indication bit, and the indication bit is at least one bit indicating the m pieces of sensing measurement result validity and the n pieces of communication data reception correctness.

In some implementations, the indication bit is m+n bits, where
m bits indicate the m pieces of sensing measurement result validity, and n bits indicate the n pieces of communication data reception correctness; or
2x bits in the m+n bits indicate x pieces of sensing measurement result validity and x pieces of communication data reception correctness through joint coding; and in a case that x is less than m, m−x bits in the m+n bits indicate m−x pieces of sensing measurement result validity, and in a case that x is less than n, n−x bits in the m+n bits indicate n−x pieces of sensing measurement result validity, where x is a positive integer, x is less than or equal to m, and x is less than or equal to n.

In some implementations, the indication bit is 2 bits, a first value of a first bit in the 2 bits indicates that at least one of the m pieces of sensing measurement result validity is invalid, and a second value of the first bit indicates that all the m pieces of sensing measurement result validity are valid; and a first value of a second bit in the 2 bits indicates that at least one of the n pieces of communication data reception correctness is incorrect, and a second value of the second bit in the 2 bits indicates that all the n pieces of communication data reception correctness are correct;
or
the indication bit is 1 bit, a second value of the first bit indicates that all the m pieces of sensing measurement result validity are valid, all the n pieces of communication data reception correctness are correct, and a first value of the 1 bit indicates at least one of the following:
at least one of the m pieces of sensing measurement result validity is invalid, and at least one of the n pieces of communication data reception correctness is incorrect.

In some implementations, the indication bit is m+n−x bits, where x bits in the m+n−x bits respectively indicate x joint indications, and each joint indication is a joint indication of one piece of sensing measurement result validity and one piece of communication data reception correctness; and in a case that x is less than m, m−x bits in the m+n−x bits indicate m−x pieces of sensing measurement result validity, and in a case that x is less than n, n−x bits in the m+n−x bits indicate n−x pieces of sensing measurement result validity, where x is a positive integer, x is less than or equal to m, and x is less than or equal to n.

In some implementations, the indication bit includes x bit groups, the x bit groups respectively indicate x joint indications, and each joint indication is a joint indication of one piece of sensing measurement result validity and one piece of communication data reception correctness, where
the x bit groups include at least one of the following:
a bit group of 1 bit, where the bit group of 1 bit indicates that communication data reception correctness in a corresponding joint indication is incorrect and sensing measurement result validity is invalid; and
a bit group of 2 bits, where a 1-bit indication in the bit group of 2 bits indicates that communication data reception correctness in a corresponding joint indication is correct, and the other 1 bit indicates sensing measurement result validity in the corresponding joint indication; and
in a case that x is less than m, the indication bit further includes m−x bits indicating m−x pieces of sensing measurement result validity; and
in a case that x is less than n, the indication bit further includes n−x bits indicating n−x pieces of sensing measurement result validity, where
x is a positive integer, x is less than or equal to m, and x is less than or equal to n.

In some implementations, the indication bit is m×u+n bits, where m×u bits respectively indicate levels of the m pieces of sensing measurement result validity, and n bits indicate the n pieces of communication data reception correctness.

In some implementations, the first indication information is further used to indicate at least one of the following:
a sensing measurement result invalidity cause; and
a parameter configuration of a target signal.

In some implementations, the sensing measurement result invalidity cause is at least one of the following:
quality of the target signal detected by the first device does not reach a threshold requirement;
a sensing measurement result obtained by the first device does not meet a sensing requirement;
the first device does not correctly demodulate data in a case that the target signal is a communication data signal; and
the first device does not obtain a sensing measurement result when a feedback time point of the first indication information arrives.

In some implementations, the parameter configuration includes at least one of the following:
a waveform, a subcarrier spacing, a guard interval, a bandwidth, burst duration, a time domain spacing, a transmit signal power, a signal format, a signal direction, a time resource, a frequency domain resource, and a quasi co-location QCL relationship.

In some implementations, the first indication information is further used to indicate at least one of the following:
identifier information of a target signal associated with a sensing measurement result;
sensing measurement identifier information;
a sensing measurement result; and
feedback information of the first indication information.

In some implementations, the feedback information of the first indication information includes at least one of the following:
a total quantity of bits of the first indication information;
a quantity of valid sensing measurement results corresponding to the first indication information;
a quantity of invalid sensing measurement results corresponding to the first indication information;
a quantity of sensing measurement results indicated in the first indication information;
a quantity of invalidity causes indicated in the first indication information;
a quantity of recommended parameter configurations of a target signal that are indicated in the first indication information;
a quantity of bits for indicating a sensing measurement result in the first indication information;
a quantity of bits for indicating an invalidity cause in the first indication information; and
a quantity of bits for indicating a recommended target signal parameter configuration in the first indication information.

In some implementations, in a case that a first piece of sensing measurement result validity indicated in the first indication information is valid, the first indication information indicates a first sensing measurement result, and the first piece of sensing measurement result validity is one of the m pieces of sensing measurement result validity;
and/or
in a case that a second sensing measurement result is valid, the first indication information indicates at least one of the following:
sensing measurement result validity of the second sensing measurement result;
identifier information of a target signal associated with the second sensing measurement result;
sensing measurement identifier information of the second sensing measurement result; and
the second sensing measurement result, where
the second sensing measurement result is one of the m sensing measurement results;
and/or
in a case that a third piece of sensing measurement result validity indicated by the first indication information is invalid, the first indication information indicates at least one of the following:
indication information of an invalidity cause of a third sensing measurement result; and
a parameter configuration of a target signal, where
the third piece of sensing measurement result validity is one of the m pieces of sensing measurement result validity;
and/or
in a case that a fourth sensing measurement result is invalid, the first indication information indicates at least one of the following:
sensing measurement result validity of the fourth sensing measurement result;
indication information of an invalidity cause of the fourth sensing measurement result; and
a parameter configuration of a target signal, where
the fourth sensing measurement result is one of the m sensing measurement results;
and/or
in a case that a fifth sensing measurement result is valid, the first indication information does not indicate related information of the fifth sensing measurement result, where
the fifth sensing measurement result is one of the m sensing measurement results;
and/or
in a case that a sixth sensing measurement result is valid, the first indication information does not indicate related information of the sixth sensing measurement result, where
the sixth sensing measurement result is one of the m sensing measurement results.

In some implementations, before sending the first indication information to the second device, the radio frequency unit 1001 is further configured to:
receive second indication information sent by the second device, where the second indication information is used to indicate at least one of the following:
whether sensing measurement result validity needs to be fed back;
a feedback configuration of sensing measurement result validity and communication data reception correctness;
a criterion for determining sensing measurement result validity;
a sensing measurement quantity;
a sensing requirement; and
a sensing service.

In some implementations, the feedback configuration of the sensing measurement result validity and the communication data reception correctness includes at least one of the following:
a feedback timing;
a feedback resource;
a feedback manner;
a joint feedback configuration or indication; and
a format of the first indication information;
and/or
the criterion for determining the sensing measurement result validity includes at least one of the following:
whether quality of the target signal detected by the first device reaches a threshold requirement;
whether a sensing measurement result obtained by the first device meets a sensing requirement;
whether the first device correctly demodulates data in a case that the target signal is a communication data signal; and
whether the first device obtains a sensing measurement result when a feedback time point of the first indication information arrives.

In some implementations, before sending the first indication information to the second device, the radio frequency unit 1001 is further configured to:
receive third indication information sent by the second device, where the third indication information is used to indicate at least one of the following:
indication information of whether sensing measurement is allowed based on a communication data symbol;
configuration information of a communication data signal for sensing measurement; and
sensing quality of service QoS information.

It should be noted that this embodiment is described by using an example in which the first device is a terminal.

The foregoing first device can implement sensing measurement.

An embodiment of this application further provides a communication device. The communication device is a second device and includes a processor and a communication interface. The communication interface is configured to receive first indication information sent by a first device, where the first indication information is used to indicate m pieces of sensing measurement result validity and n pieces of communication data reception correctness, and m+n>2, where m sensing measurement results corresponding to the m pieces of sensing measurement result validity are measurement results of performing sensing measurement on a target signal received by the first device. The embodiment of the second device corresponds to the foregoing method embodiment of the second device. Each implementation process and implementation of the foregoing method embodiment may be applicable to the embodiment of the second device.

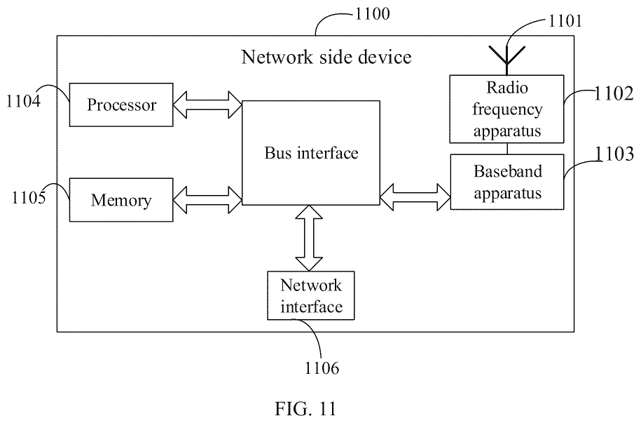

An embodiment of this application further provides a communication device, and the communication device is a second device. As shown in FIG. 11, the communication device 1100 includes an antenna 1101, a radio frequency apparatus 1102, a baseband apparatus 1103, a processor 1104, and a memory 1105. The antenna 1101 is connected to the radio frequency apparatus 1102. In an uplink direction, the radio frequency apparatus 1102 receives information by using the antenna 1101, and sends the received information to the baseband apparatus 1103 for processing. In a downlink direction, the baseband apparatus 1103 processes information that needs to be sent, and sends processed information to the radio frequency apparatus 1102. The radio frequency apparatus 1102 processes the received information, and sends processed information by using the antenna 1101.

The method performed by the communication device in the foregoing embodiment may be implemented in the baseband apparatus 1103. The baseband apparatus 1103 includes a baseband processor.

The baseband apparatus 1103 may include, for example, at least one baseband board, where a plurality of chips are disposed on the baseband board. As shown in FIG. 11, one chip is, for example, the baseband processor, is connected to the memory 1105 through a bus interface, to invoke a program in the memory 1105 to perform the operations of the network device shown in the foregoing method embodiment.

The communication device may further include a network interface 1106, and the interface is, for example, a Common Public Radio Interface (CPRI).

In some implementations, the communication device 1100 in this embodiment of this application further includes an instruction or a program that is stored in the memory 1105 and that can be run on the processor 1104. The processor 1104 invokes the instruction or the program in the memory 1105 to perform the method performed by the modules shown in FIG. 7. To avoid repetition, details are not described herein again.

The radio frequency apparatus 1102 is configured to receive first indication information sent by a first device, where the first indication information is used to indicate m pieces of sensing measurement result validity and n pieces of communication data reception correctness, and m+n>2, where
m sensing measurement results corresponding to the m pieces of sensing measurement result validity are measurement results of performing sensing measurement on a target signal received by the first device.

In some implementations, the first indication information includes an indication bit, and the indication bit is at least one bit indicating the m pieces of sensing measurement result validity and the n pieces of communication data reception correctness.

In some implementations, the indication bit is m+n bits, where
m bits indicate the m pieces of sensing measurement result validity, and n bits indicate the n pieces of communication data reception correctness; or
2x bits in the m+n bits indicate x pieces of sensing measurement result validity and x pieces of communication data reception correctness through joint coding; and in a case that x is less than m, m−x bits in the m+n bits indicate m−x pieces of sensing measurement result validity, and in a case that x is less than n, n−x bits in the m+n bits indicate n−x pieces of sensing measurement result validity, where x is a positive integer, x is less than or equal to m, and x is less than or equal to n.

In some implementations, the indication bit is 2 bits, a first value of a first bit in the 2 bits indicates that at least one of the m pieces of sensing measurement result validity is invalid, and a second value of the first bit indicates that all the m pieces of sensing measurement result validity are valid; and a first value of a second bit in the 2 bits indicates that at least one of the n pieces of communication data reception correctness is incorrect, and a second value of the second bit in the 2 bits indicates that all the n pieces of communication data reception correctness are correct;
or
the indication bit is 1 bit, a second value of the first bit indicates that all the m pieces of sensing measurement result validity are valid, all the n pieces of communication data reception correctness are correct, and a first value of the 1 bit indicates at least one of the following:
at least one of the m pieces of sensing measurement result validity is invalid, and at least one of the n pieces of communication data reception correctness is incorrect.

In some implementations, the indication bit is m+n−x bits, where x bits in the m+n−x bits respectively indicate x joint indications, and each joint indication is a joint indication of one piece of sensing measurement result validity and one piece of communication data reception correctness; and in a case that x is less than m, m−x bits in the m+n−x bits indicate m−x pieces of sensing measurement result validity, and in a case that x is less than n, n−x bits in the m+n−x bits indicate n−x pieces of sensing measurement result validity, where x is a positive integer, x is less than or equal to m, and x is less than or equal to n.

In some implementations, the indication bit includes x bit groups, the x bit groups respectively indicate x joint indications, and each joint indication is a joint indication of one piece of sensing measurement result validity and one piece of communication data reception correctness, where
the x bit groups include at least one of the following:
a bit group of 1 bit, where the bit group of 1 bit indicates that communication data reception correctness in a corresponding joint indication is incorrect and sensing measurement result validity is invalid; and
a bit group of 2 bits, where a 1-bit indication in the bit group of 2 bits indicates that communication data reception correctness in a corresponding joint indication is correct, and the other 1 bit indicates sensing measurement result validity in the corresponding joint indication; and
in a case that x is less than m, the indication bit further includes m−x bits indicating m−x pieces of sensing measurement result validity; and
in a case that x is less than n, the indication bit further includes n−x bits indicating n−x pieces of sensing measurement result validity, where
x is a positive integer, x is less than or equal to m, and x is less than or equal to n.

In some implementations, the indication bit is m×u+n bits, where m×u bits respectively indicate levels of the m pieces of sensing measurement result validity, and n bits indicate the n pieces of communication data reception correctness.

In some implementations, the first indication information is further used to indicate at least one of the following:
a sensing measurement result invalidity cause; and
a parameter configuration of a target signal.

In some implementations, the sensing measurement result invalidity cause is at least one of the following:
quality of the target signal detected by the first device does not reach a threshold requirement;
a sensing measurement result obtained by the first device does not meet a sensing requirement;
the first device does not correctly demodulate data in a case that the target signal is a communication data signal; and
the first device does not obtain a sensing measurement result when a feedback time point of the first indication information arrives.

In some implementations, the parameter configuration includes at least one of the following:
a waveform, a subcarrier spacing, a guard interval, a bandwidth, burst duration, a time domain spacing, a transmit signal power, a signal format, a signal direction, a time resource, a frequency domain resource, and a quasi co-location QCL relationship.

In some implementations, the first indication information is further used to indicate at least one of the following:
identifier information of a target signal associated with a sensing measurement result;
sensing measurement identifier information;
a sensing measurement result; and
feedback information of the first indication information.

In some implementations, the feedback information of the first indication information includes at least one of the following:
a total quantity of bits of the first indication information;
a quantity of valid sensing measurement results corresponding to the first indication information;
a quantity of invalid sensing measurement results corresponding to the first indication information;
a quantity of sensing measurement results indicated in the first indication information;
a quantity of invalidity causes indicated in the first indication information;
a quantity of recommended parameter configurations of a target signal that are indicated in the first indication information;
a quantity of bits for indicating a sensing measurement result in the first indication information;
a quantity of bits for indicating an invalidity cause in the first indication information; and
a quantity of bits for indicating a recommended target signal parameter configuration in the first indication information.

In some implementations, in a case that a first piece of sensing measurement result validity indicated in the first indication information is valid, the first indication information indicates a first sensing measurement result, and the first piece of sensing measurement result validity is one of the m pieces of sensing measurement result validity;
and/or
in a case that a second sensing measurement result is valid, the first indication information indicates at least one of the following:
sensing measurement result validity of the second sensing measurement result;
identifier information of a target signal associated with the second sensing measurement result;
sensing measurement identifier information of the second sensing measurement result; and
the second sensing measurement result, where
the second sensing measurement result is one of the m sensing measurement results;
and/or
in a case that a third piece of sensing measurement result validity indicated by the first indication information is invalid, the first indication information indicates at least one of the following:
indication information of an invalidity cause of a third sensing measurement result; and
a parameter configuration of a target signal, where
the third piece of sensing measurement result validity is one of the m pieces of sensing measurement result validity;
and/or
in a case that a fourth sensing measurement result is invalid, the first indication information indicates at least one of the following:
sensing measurement result validity of the fourth sensing measurement result;
indication information of an invalidity cause of the fourth sensing measurement result; and
a parameter configuration of a target signal, where
the fourth sensing measurement result is one of the m sensing measurement results;
and/or
in a case that a fifth sensing measurement result is valid, the first indication information does not indicate related information of the fifth sensing measurement result, where
the fifth sensing measurement result is one of the m sensing measurement results.

In some implementations, before receiving the first indication information sent by the first device, the radio frequency apparatus 1102 is further configured to:
send second indication information to the first device, where the second indication information is used to indicate at least one of the following:
whether sensing measurement result validity needs to be fed back;
a feedback configuration of sensing measurement result validity and communication data reception correctness;
a criterion for determining sensing measurement result validity;
a sensing measurement quantity;
a sensing requirement; and
a sensing service.

In some implementations, the feedback configuration of the sensing measurement result validity and the communication data reception correctness includes at least one of the following:
a feedback timing;
a feedback resource;
a feedback manner;
a joint feedback configuration or indication; and
a format of the first indication information;
and/or
the criterion for determining the sensing measurement result validity includes at least one of the following:
whether quality of the target signal detected by the first device reaches a threshold requirement;
whether a sensing measurement result obtained by the first device meets a sensing requirement;
whether the first device correctly demodulates data in a case that the target signal is a communication data signal; and
whether the first device obtains a sensing measurement result when a feedback time point of the first indication information arrives.

In some implementations, before receiving the first indication information sent by the first device, the radio frequency apparatus 1102 is further configured to:
send third indication information to the first device, where the third indication information is used to indicate at least one of the following:
indication information of whether sensing measurement is allowed based on a communication data symbol;
configuration information of a communication data signal for sensing measurement; and
sensing quality of service QoS information.

It should be noted that this embodiment is described by using an example in which the second device is a network side device.

The foregoing second device can implement sensing measurement.

An embodiment of this application further provides a readable storage medium. The readable storage medium stores a program or an instruction, and the program or the instruction is executed by a processor to implement the processes of the foregoing indication information sending method or indication information receiving method embodiment To avoid repetition, details are not described herein again.

The processor is a processor in the terminal in the foregoing embodiment. The readable storage medium includes a computer readable storage medium, such as a computer ROM, a RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing indication information sending method or indication information receiving method embodiment. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing indication information sending method or indication information receiving method embodiment. To avoid repetition, details are not described herein again.

An embodiment of this application further provides an information feedback system, including a first device and a second device. The terminal may be configured to perform the steps of the foregoing indication information sending method, and the network side device may be configured to perform the steps of the foregoing indication information receiving method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. An indication information sending method, performed by a first device, comprising:
sending first indication information to a second device, wherein the first indication information is used to indicate m pieces of sensing measurement result validity and n pieces of communication data reception correctness, m and n are positive integers, and m+n>2, wherein
m sensing measurement results corresponding to the m pieces of sensing measurement result validity are measurement results of performing sensing measurement on a target signal received by the first device.

2. The method according to claim 1, wherein the first indication information comprises an indication bit, and the indication bit is at least one bit indicating the m pieces of sensing measurement result validity and the n pieces of communication data reception correctness.

3. The method according to claim 2, wherein the indication bit is m+n bits, wherein:
m bits indicate the m pieces of sensing measurement result validity, and n bits indicate the n pieces of communication data reception correctness; or
2x bits in the m+n bits indicate x pieces of sensing measurement result validity and x pieces of communication data reception correctness through joint coding, wherein
when x is less than m, m−x bits in the m+n bits indicate m−x pieces of sensing measurement result validity, or
when x is less than n, n−x bits in the m+n bits indicate n−x pieces of sensing measurement result validity, wherein x is a positive integer, x is less than or equal to m, and x is less than or equal to n.

4. The method according to claim 2, wherein:
when the indication bit is 2 bits,
a first value of a first bit in the 2 bits indicates that at least one of the m pieces of sensing measurement result validity is invalid, and a second value of the first bit in the 2 bits indicates that all the m pieces of sensing measurement result validity are valid, and
a first value of a second bit in the 2 bits indicates that at least one of the n pieces of communication data reception correctness is incorrect, and a second value of the second bit in the 2 bits indicates that all the n pieces of communication data reception correctness are correct; or
when the indication bit is 1 bit,
a second value of the first bit indicates that all the m pieces of sensing measurement result validity are valid, all the n pieces of communication data reception correctness are correct, and
a first value of the first bit indicates at least one of the following:
at least one of the m pieces of sensing measurement result validity is invalid, or at least one of the n pieces of communication data reception correctness is incorrect.

5. The method according to claim 2, wherein:
when the indication bit is m+n−x bits, wherein x bits in the m+n−x bits respectively indicate x joint indications, and each joint indication is a joint indication of one piece of sensing measurement result validity and one piece of communication data reception correctness; and
when x is less than m, m−x bits in the m+n−x bits indicate m−x pieces of sensing measurement result validity, or
when x is less than n, n−x bits in the m+n−x bits indicate n−x pieces of sensing measurement result validity, wherein x is a positive integer, x is less than or equal to m, and x is less than or equal to n.

6. The method according to claim 2, wherein the indication bit comprises x bit groups, the x bit groups respectively indicate x joint indications, and each joint indication is a joint indication of one piece of sensing measurement result validity and one piece of communication data reception correctness, wherein
the x bit groups comprise at least one of the following:
a bit group of 1 bit, wherein the bit group of 1 bit indicates that communication data reception correctness in a corresponding joint indication is incorrect and sensing measurement result validity is invalid; or
a bit group of 2 bits, wherein a 1-bit indication in the bit group of 2 bits indicates that communication data reception correctness in a corresponding joint indication is correct, and the other 1 bit indicates sensing measurement result validity in the corresponding joint indication; and
when x is less than m, the indication bit further comprises m−x bits indicating m−x pieces of sensing measurement result validity, or
when x is less than n, the indication bit further comprises n−x bits indicating n−x pieces of sensing measurement result validity, wherein x is a positive integer, x is less than or equal to m, and x is less than or equal to n.

7. The method according to claim 2, wherein the indication bit is m×u+n bits, wherein m×u bits respectively indicate levels of the m pieces of sensing measurement result validity, and n bits indicate the n pieces of communication data reception correctness.

8. The method according to claim 1, wherein the first indication information is further used to indicate at least one of the following:
a sensing measurement result invalidity cause; or
a parameter configuration of a target signal.

9. The method according to claim 8, wherein the sensing measurement result invalidity cause is at least one of the following:
quality of the target signal detected by the first device does not reach a threshold requirement;
a sensing measurement result obtained by the first device does not meet a sensing requirement;
the first device does not correctly demodulate data when the target signal is a communication data signal; or
the first device does not obtain a sensing measurement result when a feedback time point of the first indication information arrives.

10. The method according to claim 8, wherein the parameter configuration comprises at least one of the following:
a waveform, a subcarrier spacing, a guard interval, a bandwidth, burst duration, a time domain spacing, a transmit signal power, a signal format, a signal direction, a time resource, a frequency domain resource, or a Quasi Co-Location (QCL) relationship.

11. The method according to claim 1, wherein the first indication information is further used to indicate at least one of the following:
identifier information of a target signal associated with a sensing measurement result;
sensing measurement identifier information;
a sensing measurement result; or
feedback information of the first indication information.

12. The method according to claim 11, wherein the feedback information of the first indication information comprises at least one of the following:
a total quantity of bits of the first indication information;
a quantity of valid sensing measurement results corresponding to the first indication information;
a quantity of invalid sensing measurement results corresponding to the first indication information;
a quantity of sensing measurement results indicated in the first indication information;
a quantity of invalidity causes indicated in the first indication information;
a quantity of recommended parameter configurations of a target signal that are indicated in the first indication information;
a quantity of bits for indicating a sensing measurement result in the first indication information;
a quantity of bits for indicating an invalidity cause in the first indication information; or
a quantity of bits for indicating a recommended target signal parameter configuration in the first indication information.

13. The method according to claim 1, wherein:
when a first piece of sensing measurement result validity indicated in the first indication information is valid, the first indication information indicates a first sensing measurement result, and the first piece of sensing measurement result validity is one of the m pieces of sensing measurement result validity;
when a second sensing measurement result is valid, the first indication information indicates at least one of the following:
sensing measurement result validity of the second sensing measurement result,
identifier information of a target signal associated with the second sensing measurement result,
sensing measurement identifier information of the second sensing measurement result, or
the second sensing measurement result, wherein the second sensing measurement result is one of the m sensing measurement results;
when a third piece of sensing measurement result validity indicated by the first indication information is invalid, the first indication information indicates at least one of the following:
indication information of an invalidity cause of a third sensing measurement result, or
a parameter configuration of a target signal, wherein the third piece of sensing measurement result validity is one of the m pieces of sensing measurement result validity;
when a fourth sensing measurement result is invalid, the first indication information indicates at least one of the following:
sensing measurement result validity of the fourth sensing measurement result,
indication information of an invalidity cause of the fourth sensing measurement result, or
a parameter configuration of a target signal, wherein the fourth sensing measurement result is one of the m sensing measurement results;
when a fifth sensing measurement result is valid, the first indication information does not indicate related information of the fifth sensing measurement result, wherein the fifth sensing measurement result is one of the m sensing measurement results; or
when a sixth sensing measurement result is valid, the first indication information does not indicate related information of the sixth sensing measurement result, wherein the sixth sensing measurement result is one of the m sensing measurement results.

14. The method according to claim 1, wherein before the sending first indication information to a second device, the method further comprises:
receiving second indication information sent by the second device, wherein the second indication information is used to indicate at least one of the following:
whether sensing measurement result validity needs to be fed back;
a feedback configuration of sensing measurement result validity and communication data reception correctness;
a criterion for determining sensing measurement result validity;
a sensing measurement quantity;
a sensing requirement; or
a sensing service.

15. The method according to claim 14, wherein:
the feedback configuration of the sensing measurement result validity and the communication data reception correctness comprises at least one of the following:
a feedback timing;
a feedback resource;
a feedback manner;
a joint feedback configuration or indication; or
a format of the first indication information; or
the criterion for determining the sensing measurement result validity comprises at least one of the following:
whether quality of the target signal detected by the first device reaches a threshold requirement;
whether a sensing measurement result obtained by the first device meets a sensing requirement;
whether the first device correctly demodulates data in a case that the target signal is a communication data signal; or
whether the first device obtains a sensing measurement result when a feedback time point of the first indication information arrives.

16. The method according to claim 1, wherein before the sending first indication information to a second device, the method further comprises:
receiving third indication information sent by the second device, wherein the third indication information is used to indicate at least one of the following:
indication information of whether sensing measurement is allowed based on a communication data symbol;
configuration information of a communication data signal for sensing measurement; or
sensing Quality of Service (QOS) information.

17. A first device comprising:
a memory storing computer-readable instructions; and
a processor coupled to the memory and configured to execute the computer-readable instructions, wherein the computer-readable instructions, when executed by the processor, cause the processor to perform operations comprising:
sending first indication information to a second device, wherein the first indication information is used to indicate m pieces of sensing measurement result validity and n pieces of communication data reception correctness, m and n are positive integers, and m+n>2, wherein
m sensing measurement results corresponding to the m pieces of sensing measurement result validity are measurement results of performing sensing measurement on a target signal received by the first device.

18. The first device according to claim 17, wherein the first indication information comprises an indication bit, and the indication bit is at least one bit indicating the m pieces of sensing measurement result validity and the n pieces of communication data reception correctness.

19. The first device according to claim 18, wherein the indication bit is m+n bits, wherein:
m bits indicate the m pieces of sensing measurement result validity, and n bits indicate the n pieces of communication data reception correctness; or
2x bits in the m+n bits indicate x pieces of sensing measurement result validity and x pieces of communication data reception correctness through joint coding, wherein
when x is less than m, m−x bits in the m+n bits indicate m−x pieces of sensing measurement result validity, or
when x is less than n, n−x bits in the m+n bits indicate n−x pieces of sensing measurement result validity, wherein x is a positive integer, x is less than or equal to m, and x is less than or equal to n.

20. A non-transitory computer-readable medium storing instructions that, when executed by a processor of a first device, cause the processor to perform operations comprising:
sending first indication information to a second device, wherein the first indication information is used to indicate m pieces of sensing measurement result validity and n pieces of communication data reception correctness, m and n are positive integers, and m+n>2, wherein
m sensing measurement results corresponding to the m pieces of sensing measurement result validity are measurement results of performing sensing measurement on a target signal received by the first device.
